(19) United States
(12) Patent Application Publication
(10) Pub. No.: US 2022/0315781 A1
(43) Pub. Date: Oct. 6, 2022

(54) White Ink Jet Composition And Ink Jet Recording Method

(71) Applicant: Seiko Epson Corporation, Tokyo (JP)

(72) Inventors: Kazuto AOKI, Shiojiri (JP); Ryota MIYASA, Matsumoto (JP)

(21) Appl. No.: 17/705,761

(22) Filed: Mar. 28, 2022

(30) Foreign Application Priority Data
Mar. 29, 2021 (JP) 2021-054998

(51) Int. Cl. C09D 11/107; C09D 11/36; C09D 11/033; C09D 11/102; C09D 11/32; B41M 5/00; B41J 2/21

(52) U.S. Cl. CPC C09D 11/107; C09D 11/36; C09D 11/033; C09D 11/102; C09D 11/32; B41M 5/0023; B41J 2/2114

(57) ABSTRACT

A white ink jet ink composition including hollow resin particles, resin particles, and water, in which a glass transition temperature of the hollow resin particles is 120° C. or higher, and a glass transition temperature of the resin particles is 5° C. or lower.

The present application is based on, and claims priority from JP Application Serial Number 2021-054998, filed Mar. 29, 2021, the disclosure of which is hereby incorporated by reference herein in its entirety.

### BACKGROUND

### 1. Technical Field

The present disclosure relates to a white ink jet ink composition and an ink jet recording method.

### 2. Related Art

Since an ink jet method can form a high-quality image on a recording medium, various technological developments were carried out in the related art. Not only the development of an ink jet recording device, but also the study on an ink composition used for this or the study on the ink composition or a recording method according to a target recording medium and the like are being carried out in an extremely wide range.

For example, JP-A-2017-179263 discloses an aqueous white pigment ink for ink jet recording used for a cloth, which attempts to enhance washing robustness of the white pigment remaining on a surface of the cloth by making it difficult for a white pigment in the ink to penetrate into the inside of the cloth to improve the whiteness on the cloth, using a binding agent.

However, when a white image is recorded on a cloth by the ink jet method, it is required to suppress the precipitation of the white pigment in the used ink and improve color developing properties of the image, but fabric followingness of the image is required. That is, depending on the type of the cloth, a white ink jet ink composition that suppresses image cracking due to expansion and contraction of the fabric is required.

### SUMMARY

An aspect of the white ink jet ink composition according to the present disclosure includes hollow resin particles, resin particles, and water, in which a glass transition temperature of the hollow resin particles is 120° C. or higher, and a glass transition temperature of the resin particles is 5° C. or lower.

An ink jet recording method according to an aspect of the present disclosure includes a white ink adhesion step of ejecting the above-mentioned white ink jet ink composition from a recording head and adhering the ejected composition to a recording medium.

### BRIEF DESCRIPTION OF THE DRAWINGS

FIG. 1 is a perspective view schematically showing a schematic configuration of a first embodiment of a recording device in a fluoroscopic state.

FIG. 2 is a perspective view showing an ink supply unit provided in a housing of a recording device.

FIG. 3 is a plan view of an ink supply unit.

FIG. 4 is a partial cross-sectional view taken along the line IV-IV in FIG. 3.

FIG. 5 is a partial cross-sectional view taken along the line V-V in FIG. 3.

FIG. 6 is a perspective view of an ink accommodating body in a state of a cap being removed.

FIG. 7 is a side view of an ink accommodating body.

FIG. 8 is a front view of an ink accommodating body.

FIG. 9 is a plan view of an ink accommodating body.

FIG. 10 is a cross-sectional view taken along the line X-X in FIG. 9.

FIG. 11 is a cross-sectional view taken along the line XI-XI in FIG. 9.

FIG. 12 is a partially broken front view showing a state immediately before the ink replenishment work for an ink accommodating body.

FIG. 13 is a partially broken side view showing a state immediately before the ink replenishment work for an ink accommodating body.

FIG. 14 is a partially broken front view showing a state during the ink replenishment work for an ink accommodating body.

FIG. 15 is a partially broken side view showing a state during the ink replenishment work for an ink accommodating body.

FIG. 16 is a partially broken front view showing a state in which a positioning portion of an ink accommodating body is in contact with a receiving surface on the ink accommodating body side during ink replenishment.

FIG. 17 is a partially broken side view showing a state in which a positioning portion of an ink accommodating body is in contact with a receiving surface on the ink accommodating body side during ink replenishment.

### DESCRIPTION OF EXEMPLARY EMBODIMENTS

Hereinafter, embodiments of the present disclosure will be described. The embodiments described below describe examples of the present disclosure. The present disclosure is not limited to the following embodiments, and includes various modifications implemented within a range not changing a gist of the present disclosure. It should be noted that not all of the configurations described below are essential configurations of the present disclosure.

In the present specification, “(meth) acrylic” means acrylic or methacrylic, and “(meth)acrylate” means acrylate or methacrylate.

### 1. WHITE INK JET INK COMPOSITION

The white ink jet ink composition according to the present embodiment contains hollow resin particles, resin particles, and water.

### 1.1. Hollow Resin Particles

The hollow resin particles contained in the white ink jet ink composition of the present embodiment have a glass transition temperature (Tg) of 120° C. or higher. That is, the Tg of the polymer constituting the hollow resin particles is 120° C. or higher. By using such hollow resin particles, a structure of the hollow resin particles is unlikely to change when the white ink jet ink composition adhering to a recording medium is dried by heating. Therefore, the scattering of light by the hollow resin particles is less likely to change, and good color development can be maintained.

The hollow resin particles are not particularly limited as long as the Tg is 120° C. or higher, and known ones can be used. For example, among the hollow resin particles as described in the specification of U.S. Pat. No. 4,880,465, Japanese Patent No. 3,562,754, and the like, those having a Tg of 120° C. or higher can be used.

Hollow resin particles refer to resin particles having voids inside the resin particles and in a state of the voids being filled with liquid or gas. As a method for determining the hollowness, in a case of having a structure in which voids are recognized inside the particles, when a cross section of the particle is observed with a scanning electron microscope, it is determined that the particle is a hollow resin particle. Alternatively, as a method for determining the hollowness, in a case of having a structure in which a difference in contrast between transmission electrons is recognized when the particle is observed with a transmission electron microscope, it is determined that the particle is a hollow resin particle. In transmission electron microscope observation, when the resin particles have voids inside, since electron beams easily pass through internal voids and the contrast is observed brightly, depending on the presence or absence of a difference in contrast of the transmission electrons, it is possible to determine the presence or absence of the internal voids.

The hollow resin particles may be prepared and used, or commercially available products may be used. As a method for preparing the hollow resin particles, for example, a so-called emulsification polymerization method in which a monomer, a surfactant, a polymerization initiator, and an aqueous dispersion medium are stirred while heating in a nitrogen atmosphere to form a hollow resin particle emulsion can be applied.

As the monomer, a nonionic monoethylene unsaturated monomer is exemplified, and examples thereof include styrene, vinyltoluene, ethylene, vinyl acetate, vinyl chloride, vinylidene chloride, acrylonitrile, and the like. In addition, as the monomer, (meth)acrylic acid and derivatives thereof may be used, and examples thereof include (meth)acrylic acid, (meth)acrylamide, and (meth)acrylic acid ester. Examples of the (meth)acrylic acid ester include methyl acrylate, methyl methacrylate, ethyl (meth)acrylate, butyl (meth)acrylate, 2-hydroxyethyl methacrylate, 2-ethylhexyl (meth)acrylate, benzyl (meth)acrylate, lauryl (meth)acrylate, oleyl (meth)acrylate, palmityl (meth)acrylate, stearyl (meth)acrylate, and the like.

In addition, a bifunctional monomer can also be used as the monomer. Examples of the bifunctional vinyl monomer include divinylbenzene, and examples of the bifunctional (meth)acrylic monomer include allyl methacrylate, ethylene glycol dimethacrylate, 1,3-butanediol dimethacrylate, diethylene glycol dimethacrylate, trimethylolpropane trimethacrylate, and the like. By copolymerizing a monofunctional monomer and a bifunctional monomer and highly cross-linking thereof, hollow resin particles having properties such as heat resistance, solvent resistance, and solvent dispersibility as well as light scattering properties can be obtained.

The surfactant may be any one that forms molecular aggregates such as micelles in water, and examples thereof include an anionic surfactant, a nonionic surfactant, a cationic surfactant, an amphoteric surfactant, and the like.

As the polymerization initiator, a known compound that is soluble in water can be used, and examples thereof include hydrogen peroxide, potassium persulfate, and the like.

Examples of the aqueous dispersion medium include water, water containing a hydrophilic organic solvent, and the like.

On the other hand, as the hollow resin particles, a commercially available product may be used. Examples of commercially available products include ROPAQUE HT1432 (product name manufactured by Dow Chemical Co., Ltd., styrene-acrylic resin, Tg: 123° C., particle size 500 nm) and the like. These may be used alone or in combination of two or more.

In the present specification, a polymer containing a (meth)acrylic acid derivative as a repeating unit is referred to as an “acrylic resin”. For example, the above-exemplified “styrene-acrylic resin”, “crosslinked styrene-acrylic resin”, “modified styrene-acrylic resin”, and the like are “acrylic resins”.

The resin composition of the hollow resin particles may be an acrylic resin, a urethane-based resin, a mallein-based resin, and the like, and these may be used alone or in combination of two or more.

In addition, although the glass transition temperature depends on the resin composition of the hollow resin particles, the glass transition temperature (Tg) of the hollow resin particles is preferably 125° C. or higher, more preferably 130° C. or higher, and still more preferably 135° C. or higher. The Tg of the hollow resin particles is preferably equal to or higher than a surface temperature of a recording medium heated in a heating and drying step in the ink jet recording method. Considering the whiteness of the image formed by the white ink jet ink composition, an upper limit of Tg is not particularly limited. However, when Tg is too high, the fabric followingness of the image may deteriorate. An upper limit value of the glass transition temperature of the hollow resin particles is not particularly limited, but is, for example, preferably 180° C. or lower, more preferably 170° C. or lower, and still more preferably 160° C. or lower.

In addition, the material of the hollow resin particles preferably contains an acrylic resin, and with this, the hollow resin particles having a glass transition temperature of 120° C. or higher can be easily obtained and the glass transition temperature can be adjusted more easily.

When the hollow resin particles are polymerized, the glass transition temperature of the hollow resin particles can be changed by changing at least one of the type and composition ratio of the used monomers, the polymerization conditions, and modification of the resin. Examples of the polymerization conditions include a temperature at the time of polymerization, a type of a medium containing a monomer, a concentration of the monomer in the medium, a type or amount of the polymerization initiator or the catalyst used at the time of polymerization, and the like. The glass transition temperature can be measured by the differential scanning calorimetry method (DSC method) based on JIS K7121.

A content (solid content) of the hollow resin particles is preferably 1% by mass or more and 20% by mass or less, and more preferably 5% by mass or more and 15% by mass or less with respect to the total amount of the white ink jet ink composition. Within this range, in particular, as the content (solid content) of the hollow resin particles does not exceed 20% by mass, the reliability such as clogging of the ink jet recording head is improved, and as the content is less than 1% by mass, sufficient color density such as whiteness is ensured.

In addition, the hollow resin particles preferably have a resin as a shell and contain gas such as air. Hollow refers to a structure in which the inside of an object is empty, specifically, a structure having at least one of a space that can contain gas such as air and a hole through which gas such as air can always pass. The hollow resin particles are white and have excellent opacity due to light scattering due to the difference in refractive index between an air layer inside the particles after drying and a polymer layer of the shell.

It is desired that the hollow resin particles do not precipitate or float and separate in the white ink jet ink composition. Therefore, the specific gravity may be appropriately adjusted. For example, the dispersion stability in the ink can be adjusted by adjusting the thickness of the shell of the hollow resin particles or adjusting the specific gravity of the polymer constituting the shell. In addition, the hollow resin particles may have a structure in which the white ink jet ink composition is filled with a vehicle component mainly constituted of water or an organic solvent, and the specific gravity of the hollow resin particles can be changed close to the specific gravity of the vehicle component. With this, it is possible to suppress the precipitation or floating of the hollow resin particles in the white ink jet ink composition.

In addition, when the white ink jet ink composition is dried, the hollow resin particles have more remarkable light scattering due to the evaporation of the vehicle component and the interface between the polymer of the shell and the inner cavity, resulting in presenting a more favorable white color.

An average particle size (outer diameter) of the hollow resin particles is preferably 200 nm or more and 1.5 μm or less, more preferably 300 nm or more and 1.0 μm or less, and still more preferably 400 nm or more and 800 nm or less. The inner diameter of the hollow resin particles is preferably about 50 nm or more and 1.2 μm or less.

The average particle size of the hollow resin particles can be measured by a particle size distribution measuring device having a laser diffraction scattering method as a measurement principle. As a laser diffraction type particle size distribution measuring device, for example, a particle size distribution meter having a dynamic light scattering method (for example, “Microtrack UPA” manufactured by Nikkiso Co., Ltd.) as a measurement principle can be used to obtain a volume-based average particle size.

The white ink jet ink composition may contain other color materials in addition to the hollow resin particles. As other color materials, general-purpose pigments and dyes can be used.

### 1.2. Resin Particles

The white ink jet ink composition contains resin particles. The resin particles contained in the white ink jet ink composition have a glass transition temperature (Tg) of 5.0° C. or lower. That is, the Tg of the polymer constituting the resin particles is 5.0° C. or lower. By using such resin particles, the white ink jet ink composition adhering to the recording medium can be more easily fixed. In addition, by using resin particles having a Tg of 5.0° C. or lower, hollow resin particles having a Tg of 120° C. or higher can be favorably fixed. In addition, by using the resin particles having a Tg of 5.0° C. or lower, even when the recording medium expands and contracts, the resin particles easily expand and contract following the expansion and contraction, and it is possible to suppress cracking of the image and the like. Unlike the hollow resin particles, the resin particles have a solid shape, not a hollow shape.

Examples of the resin particles include those having a Tg of 5° C. or lower, among resin particles including a urethane-based resin, an acrylic resin (including styrene-acrylic resin), a fluorene-based resin, an olefin-based resin, a rosin-modified resin, a terpene-based resin, an ester-based resin, an amide-based resin, an epoxy-based resin, a vinyl chloride-based resin, and a vinyl chloride-vinyl acetate copolymer, an ethylene vinyl acetate-based resin, and the like. Among these, a urethane-based resin, an acrylic resin, an olefin-based resin, and an ester-based resin are preferable. In addition, the resin particles may be used alone or in combination of two or more.

A urethane-based resin is a general term for a resin having a urethane bond. For the urethane-based resin, a polyether-type urethane resin including an ether bond in the main chain, an ester-type urethane resin including an ester bond in the main chain, a carbonate-type urethane resin including a carbonate bond in the main chain, and the like, in addition to a urethane bond, may be used. In addition, as the urethane-based resin, commercially available products may be used, for example, from commercially available products such as Superflex 460, 460s, 840, E-4000 (product name, manufactured by DKS Co., Ltd.), Resamine D-1060, D-2020, D-4080, D-4200, D-6300, D-6455 (product name, manufactured by Dainichiseika Color & Chemicals MFG Co., Ltd.), Takelac WS-5100, WS-6021, W-512-A-6 (product name, manufactured by Mitsui Chemicals Polyurethane Co., Ltd.), Sancure 2710 (product name, manufactured by LUBRIZOL), and Permarin UA-150 (product name, manufactured by Sanyo Chemical Industries Ltd.), those having a Tg of 5° C. or lower may be selected and used.

An acrylic resin is a general term for polymers obtained by polymerizing at least an acrylic monomer such as (meth)acrylic acid and (meth)acrylic acid ester as one component, and examples thereof include a resin obtained from an acrylic monomer, a copolymer of an acrylic monomer and a monomer other than acrylic monomer, and the like. For example, an acrylic-vinyl resin which is a copolymer of an acrylic monomer and a vinyl-based monomer is exemplified. In addition, examples of the vinyl-based monomer include styrene and the like.

As the acrylic monomer, acrylamide, acrylonitrile, and the like can also be used. For a resin emulsion made from acrylic resin, a commercially available product may be used, for example, a resin emulsion selected from FK-854 (product name, manufactured by Chirika Co., Ltd.), Movinyl 952B, 718A (product name, manufactured by Nippon Synthetic Chemical Industry Co., Ltd.), Nipol LX852, LX874 (product name, manufactured by Nippon Zeon Co., Ltd.), and the like may be used.

The notation “acrylic resin” is the same as that described for the hollow resin particles described above.

The styrene acrylic resin is a copolymer obtained from a styrene monomer and a (meth)acrylic monomer, and examples thereof include a styrene-acrylic acid copolymer, a styrene-methacrylic acid copolymer, a styrene-methacrylic acid-acrylic acid ester copolymer, a styrene-α-methylstyrene-acrylic acid copolymer, a styrene-α-methylstyrene-acrylic acid-acrylic acid ester copolymer, and the like. As the styrene acrylic resin, a commercially available product may be used, for example, Joncryl 62J, 7100, 390, 711, 511, 7001, 632, 741, 450, 840, 74J, HRC-1645J, 734, 852, 7600, 775, 537J, 1535, PDX-7630A, 352J, 352D, PDX-7145, 538J, 7640, 7641, 631, 790, 780, 7610 (product name, manufactured by BASF), Movinyl 966A, 975N (product name, manufactured by Nippon Synthetic Chemical Industry Co., Ltd.), Vinyblan 2586 (manufactured by Nissin Chemical Industry Co., Ltd.), and the like may be used.

The olefin-based resin is a polymer having olefin such as ethylene, propylene, and butylene in the structural skeleton, and known ones can be appropriately selected and used. As the olefin-based resin, a commercially available product can be used, for example, Arrowbase CB-1200, CD-1200 (product name, manufactured by Unitika Ltd.), and the like may be used.

In addition, the resin particles may be supplied in the form of an emulsion, and examples of commercially available products of such a resin emulsion include Microgel E-1002, E-5002 (product name manufactured by Nippon Paint Co., Ltd., styrene-acrylic resin emulsion), Boncoat 4001 (product name manufactured by DIC Corporation, acrylic resin emulsion), Boncoat 5454 (product name manufactured by DIC Corporation, styrene-acrylic resin emulsion), Polysol AM-710, AM-920, AM-2300, AP-4735, AT-860, PSASE-4210E (acrylic resin emulsion), Polysol AP-7020 (styrene/acrylic resin emulsion), Polysol SH-502 (vinyl acetate resin emulsion), Polysol AD-13, AD-2, AD-10, AD-96, AD-17, AD-70 (ethylene/vinyl acetate resin emulsion), Polysol PSASE-6010 (ethylene/vinyl acetate resin emulsion) (product name manufactured by Showa Denko Co., Ltd.), Polysol SAE1014 (product name, styrene-acrylic resin emulsion, manufactured by Nippon Zeon Co., Ltd.), Cybinol SK-200 (product name, acrylic resin emulsion, manufactured by Saiden Chemical Co., Ltd.), AE-120A (product name manufactured by JSR, acrylic resin emulsion), AE373D (product name manufactured by E-Tec Co., Ltd., carboxy-modified styrene/acrylic resin emulsion), Seikadyne 1900W (product name manufactured by Dainichiseika Color & Chemicals MFG Co., Ltd., ethylene/vinyl acetate resin emulsion), Vinyblan 2682 (acrylic resin emulsion), Vinyblan 2886 (vinyl acetate/acrylic resin emulsion), Vinyblan 5202 (acrylic acetate resin emulsion) (product name manufactured by Nissin Chemical Industry Co., Ltd.), Elitel KA-5071S, KT-8803, KT-9204, KT-8701, KT-8904, KT-0507 (product name manufactured by Unitika Ltd., polyester resin emulsion), Hi-Tech SN-2002 (product name manufactured by Toho Chemical Industry Co., Ltd., polyester resin emulsion), Takelac W-6020, W-635, W-6061, W-605, W-635, W-6021 (product name manufactured by Mitsui Chemicals Polyurethane Co., Ltd., urethane-based resin emulsion), Superflex 870, 800, 150, 420, 460, 470, 610, 700 (product name manufactured by DKS Co., Ltd., urethane-based resin emulsion), Permarin UA-150 (manufactured by Sanyo Chemical Industries Ltd., urethane-based resin emulsion), Sancure 2710 (manufactured by Nippon Lubrizol, urethane-based resin emulsion), NeoRez R-9660, R-9637, R-940 (manufactured by Kusumoto Chemicals Ltd., urethane-based resin emulsion), Adeka Bontighter HUX-380, 290K (manufactured by ADEKA Corporation, urethane-based resin emulsion), Movinyl 966A, Movinyl 7320 (manufactured by Nippon Synthetic Chemical Industry Co., Ltd.), Joncryl 7100, 390, 711, 511, 7001, 632, 741, 450, 840, 74J, HRC-1645J, 734, 852, 7600, 775, 537J, 1535, PDX-7630A, 352J, 352D, PDX-7145, 538J, 7640, 7641, 631, 790, 780, 7610 (hereinabove, manufactured by BASF), NK binder R-5HN (manufactured by Shin Nakamura Chemical Industry Co., Ltd.), Hydran WLS-210 (non-crosslinkable polyurethane: manufactured by DIC Corporation), Joncryl 7610 (manufactured by BASF), and the like.

The resin particles are preferably selected from a urethane-based resin and an acrylic resin. By doing so, the fabric followingness of the image formed by the white ink jet ink composition tends to be further improved.

In addition, a lower limit of the glass transition temperature of the resin particles is not particularly limited, but is preferably −35° C. or higher, and more preferably −30° C. or higher in that the storage stability of the white ink jet ink composition can be improved and the clogging of the nozzle can be further suppressed. In addition, an upper limit of the glass transition temperature of the resin particles is not particularly limited, but is preferably 0° C. or lower, more preferably −15° C. or lower, and still more preferably −20° C. or lower.

A content of the resin particles in the white ink jet ink composition is 0.1% by mass or more and 15% by mass or less, preferably 1% by mass or more and 15% by mass or less, more preferably 2% by mass or more and 10% by mass or less, and still more preferably 3% by mass or more and 7% by mass or less, as a solid content with respect to the total mass of the white ink jet ink composition.

### 1.3. Water

The white ink jet ink composition according to the present embodiment contains water. Examples of the water include pure water such as ion-exchanged water, ultra-filtered water, reverse osmosis water, and distilled water, and water having reduced ionic impurities such as ultrapure water. In addition, when water sterilized by irradiation with ultraviolet rays or addition of hydrogen peroxide or the like is used, the generation of bacteria and fungi can be suppressed when the white ink jet ink composition is stored for a long period of time.

A content of water is 30% by mass or more, preferably 40% by mass or more, more preferably 45% by mass or more, and still more preferably 50% by mass or more, with respect to the total amount of the white ink jet ink composition. In the case of water in a white ink jet ink composition, for example, the water includes when water is included in the raw material and water to be added. When the water content is 30% by mass or more, the white ink jet ink composition can have a relatively low viscosity. In addition, an upper limit of the water content is preferably 90% by mass or less, more preferably 85% by mass or less, and still more preferably 80% by mass or less with respect to the total amount of the white ink jet ink composition.

### 1.4. Other Components

The white ink jet ink composition may contain the following components as components other than the hollow resin particles, the resin particles, and water.

### 1.4.1. Organic Solvent

The white ink jet ink composition according to the present embodiment may contain an organic solvent. The organic solvent is preferably a water-soluble organic solvent. One of the functions of the organic solvent is to improve the wettability of the ink with respect to a recording medium and to improve moisturizing properties of the ink. Examples of the water-soluble organic solvent include polyhydric alcohol, alkylene glycol ethers, esters, cyclic esters, nitrogen-containing solvents, and the like.

### Polyhydric Alcohol

Examples of the polyhydric alcohol include a polyhydric alcohol having a standard boiling point of 270° C. or higher, a polyhydric alcohol having a standard boiling point of 150° C. or higher and lower than 270° C., and the like.

### Standard Boiling Point is 270° C. or Higher

Examples of polyhydric alcohols having a standard boiling point of 270° C. or higher include triethylene glycol (standard boiling point: 287° C.), glycerin (standard boiling point: 290° C.), trimethylolpropane (standard boiling point: 295° C.), polyethylene glycol monomethyl ether, and the like. Standard boiling point is 150° C. or higher and lower than 270° C.

Examples of the polyhydric alcohol having a standard boiling point of 150° C. or higher and lower than 270° C. include 1,2-alkanediols and polyols.

Examples of 1,2-alkanediols include ethylene glycol, propylene glycol, 1,2-butanediol, 1,2-pentanediol, 1,2-hexanediol, 1,2-heptanediol, 1,2-octanediol and the like.

Examples of the polyols include diethylene glycol, dipropylene glycol, 1,3-propanediol, 1,3-butanediol, 1,4-butanediol, 1,5-pentanediol, 1,6-hexanediol, 2-ethyl-2-methyl-1,3-propanediol, 2-methyl-2-propyl-1,3-propanediol, 2-methyl-1,3-propanediol, 2,2-dimethyl-1,3-propanediol, 3-methyl-1,3-butanediol, 2-ethyl-1,3-hexanediol, 3-methyl-1,5-pentanediol, 2-methylpentane-2,4-diol, and the like.

### Alkylene Glycol Ethers

The alkylene glycol ethers may be alkylene glycol monoethers or diethers, and alkyl ethers are preferable.

Examples of the alkylene glycol monoalkyl ethers include ethylene glycol monomethyl ether, ethylene glycol monoethyl ether, ethylene glycol monoisopropyl ether, ethylene glycol monobutyl ether, diethylene glycol monomethyl ether, diethylene glycol monoethyl ether, diethylene glycol monobutyl ether, triethielene glycol monomethyl ether, triethylene glycol monoethyl ether, triethylene glycol monobutyl ether, tetraethylene glycol monomethyl ether, tetraethylene glycol monoethyl ether, tetraethylene glycol monobutyl ether, propylene glycol monomethyl ether, propylene glycol monoethyl ether, propylene glycol monopropyl ether, propylene glycol monobutyl ether, dipropylene glycol monomethyl ether, dipropylene glycol monoethyl ether, dipropylene glycol monopropyl ether, dipropylene glycol monobutyl ether, tripropylene glycol monobutyl ether, and the like. The alkylene glycol monoalkyl ether may be classified as a monohydric alcohol.

Examples of the alkylene glycol dialkyl ethers include ethylene glycol dimethyl ether, ethylene glycol diethyl ether, ethylene glycol dibutyl ether, diethylene glycol dimethyl ether, diethylene glycol diethyl ether, diethylene glycol dibutyl ether, diethylene glycol methyl ethyl ether, diethylene glycol methyl butyl ether, triethylene glycol dimethyl ether, triethylene glycol diethyl ether, triethylene glycol dibutyl ether, triethylene glycol methyl butyl ether, tetraethylene glycol dimethyl ether, tetraethylene glycol diethyl ether, tetraethylene glycol dibutyl ether, propylene glycol dimethyl ether, propylene glycol diethyl ether, dipropylene glycol dimethyl ether, dipropylene glycol diethyl ether, tripropylene glycol dimethyl ether, and the like.

### Esters

Examples of the esters include glycol monoacetates, glycol diesters, and the like.

Examples of glycol monoacetates include ethylene glycol monomethyl ether acetate, ethylene glycol monoethyl ether acetate, ethylene glycol monobutyl ether acetate, diethylene glycol monomethyl ether acetate, diethylene glycol monoethyl ether acetate, diethylene glycol monobutyl ether acetate, propylene glycol monomethyl ether acetate, dipropylene glycol monomethyl ether acetate, methoxybutyl acetate, and the like.

Examples of glycol diesters include ethylene glycol diacetate, diethylene glycol diacetate, propylene glycol diacetate, dipropylene glycol diacetate, ethylene glycol acetate propionate, ethylene glycol acetate butyrate, diethylene glycol acetate butyrate, diethylene glycol acetate propionate, diethylene glycol acetate butyrate, propylene glycol acetate propionate, propylene glycol acetate butyrate, dipropylene glycol acetate butyrate, dipropylene glycol acetate propionate, and the like.

### Cyclic Esters

Examples of cyclic esters include cyclic esters (lactones) such as β-propiolactone, γ-butyrolactone, δ-valerolactone, ε-caprolactone, β-butyrolactone, β-valerolactone, γ-valerolactone, β-hexanolactone, γ-hexanolactone, δ-hexanolactone, β-heptanolactone, γ-heptanolactone, δ-heptanolactone, ε-heptanolactone, γ-octanolactone, δ-octanolactone, ε-octanolactone, δ-nonalactone, ε-nonalactone, and ε-decanolactone; compounds in which a hydrogen of a methylene group adjacent to the carbonyl group is substituted by an alkyl group having 1 to 4 carbon atoms, and the like.

### Nitrogen-Containing Solvent

Examples of the nitrogen-containing solvent include cyclic amides, acyclic amides, and the like. Examples of the acyclic amides include alkoxyalkylamides and the like.

### Cyclic Amides

Examples of cyclic amides include lactams, and examples thereof include pyrrolidones such as 2-pyrrolidone, 1-methyl-2-pyrrolidone, 1-ethyl-2-pyrrolidone, 1-propyl-2-pyrrolidone, 1-butyl-2-pyrrolidone, and the like. These are preferable in terms of promoting film formation of the resin particles, and 2-pyrrolidone is particularly preferable.

### Acyclic Amides

Examples of alkoxyalkylamides include 3-methoxy-N, N-diethylpropionamide, 3-methoxy-N,N-diethylpropionamide, 3-methoxy-N,N-methylethylpropionamide, 3-ethoxy-N,N-dimethylpropionamide, 3-ethoxy-N,N-diethylpropionamide, 3-ethoxy-N,N-methylethylpropionamide, 3-n-butoxy-N,N-dimethylpropionamide, 3-n-butoxy-N,N-diethylpropionamide, 3-n-butoxy-N,N-methylethylpropionamide, 3-n-propoxy-N,N-dimethylpropionamide, 3-n-propoxy-N, N-diethylpropionamide, 3-n-propoxy-N,N-methylethylpropionamide, 3-iso-propoxy-N,N-dimethylpropionamide, 3-iso-propoxy-N,N-diethylpropionamide, 3-iso-propoxy-N,N-methylethylpropionamide, 3-tert-butoxy-N,N-dimethylpropionamide, 3-tert-butoxy-N,N-diethylpropionamide, 3-tert-butoxy-N,N-methylethylpropionamide, and the like.

In addition, as the acyclic amides, it is also preferable to use alkoxyalkylamides which are compounds represented by General Formula (1).

R¹—O—CH₂CH₂—(C═O)—NR²R³ (1)

In Formula (1), R¹ represents an alkyl group having 1 or more and 4 or less carbon atoms, and R² and R³ each independently represent a methyl group or an ethyl group. The “alkyl group having 1 or more and 4 or less carbon atoms” can be a linear or branched alkyl group, and can be, for example, a methyl group, an ethyl group, an n-propyl group, an iso-propyl group, an n-butyl group, a sec-butyl group, an iso-butyl group, and a tert-butyl group. The compound represented by Formula (1) may be used alone, or may be used in combination of two or more.

These organic solvents may be used alone or in combination of two or more.

The white ink jet ink composition of the present embodiment preferably contains an alkanediol having a standard boiling point of 240° C. or lower, having at least one hydroxyl group bonded to other than a terminal of an alkane chain, and having 4 to 6 carbon atoms, and a content thereof is more preferably 75.0% by mass or more with respect to a total amount of the water-soluble organic solvent.

By doing so, even if a white image formed on the recording medium is rapidly heated and dried, a decrease in the whiteness of the white image can be suppressed.

The carbon number of an alkanediol having a standard boiling point of 240° C. or lower, at least one hydroxyl group bonded to other than a terminal of an alkane chain, and having 4 or more and 6 or less carbon atoms is 4 or more and 6 or less, and 4 or more and 5 or less is preferable. When the number of carbon atoms is 4 or more and 6 or less, it is preferable in terms of suppressing softening of the hollow resin particles and improving drying properties of the white ink jet ink composition after image formation.

The alkanediol having a standard boiling point of 240° C. or lower, having at least one hydroxyl group bonded to other than a terminal of the alkane chain, and having 4 or more and 6 or less carbon atoms may be one in which at least one of the alcoholic hydroxyl groups is bonded to other than the terminal of the alkane chain. Since at least one hydroxyl group is bonded to other than the terminal of the alkane chain, the whiteness of the white image can be improved.

Examples of the alkanediol having a standard boiling point of 240° C. or lower, having at least one hydroxyl group bonded to other than the terminal of the alkane chain, and having 4 or more and 6 or less carbon atoms include 1,2-butanediol (standard boiling point: 194° C.), 1,3-butanediol (standard boiling point: 203° C.), 2,3-butanediol (standard boiling point: 183° C.), 1,2-propanediol (standard boiling point: 188° C.), 3-methyl-1,3-butanediol (standard boiling point: 203° C.), 2-methyl-2,4-pentanediol (standard boiling point: 197° C.), and the like. These may be used alone or in combination of two or more.

Among these, from a viewpoint of the whiteness of the white image, 1,2-butanediol, 1,3-butanediol, 2,3-butanediol, 3-methyl-1,3-butanediol, 2-methyl-2,4-pentanediol are preferable, and 3-methyl-1,3-butanediol and 2-methyl-2,4-pentanediol are more preferable.

A content of alkanediol having a standard boiling point of 240° C. or lower, having at least one hydroxyl group bonded to other than a terminal of an alkane chain, and having 4 or more and 6 or less carbon atoms is more preferably 80.0% by mass or more and still more preferably 88.0% by mass or more with respect to the total amount of the water-soluble organic solvent.

### 1.4.2. pH Regulator

The white ink jet ink composition according to the present embodiment may contain a pH regulator. The pH regulator is not particularly limited, and examples thereof include acids, bases, weak acids, weak bases, and appropriate combinations thereof, and examples thereof include tertiary alkanolamines such as triethanolamine and triisopropanolamine. When adding a pH regulator, for example, a content of the pH regulator is preferably 0.01% by mass or more and 2.0% by mass or less, more preferably 0.1% by mass or more and 1.0 by mass or less, and still more preferably 0.2% by mass or more and 0.5% by mass or less in total with respect to the total mass of the ink composition.

### 1.4.3. Surfactant

The white ink jet ink composition according to the present embodiment may contain a surfactant. The surfactant can be used as a wetting agent for reducing a surface tension of the ink composition and adjusting the wettability or permeability to the recording medium. In addition, since the ink composition contains a surfactant, the ejection reliability from an ink jet head is ensured.

As the surfactant, any of a nonionic surfactant, an anionic surfactant, a cationic surfactant, and an amphoteric surfactant can be used, and these may be used in combination. In addition, among the surfactants, acetylene glycol-based surfactants, silicone-based surfactants, and fluorine-based surfactants can be preferably used.

The acetylene glycol-based surfactant is not particularly limited, and examples thereof include Surfinol (registered trademark) 104, 104E, 104H, 104A, 104BC, 104DPM, 104PA, 104PG-50, 104S, 420, 440, 465, 485, SE, SE-F, 504, 61, DF37, CT111, CT121, CT131, CT136, TG, GA, DF110D (hereinabove, product names, manufactured by Nissin Chemical Co., Ltd.), Orfin (registered trademark) B, Y, P, A, STG, SPC, E1004, E1010, PD-001, PD-002W, PD-003, PD-004, PD-005, EXP. 4001, EXP. 4300, EXP. 4036, EXP. 4051, AF-103, AF-104, AK-02, SK-14, AE-3 (hereinabove, product names, manufactured by Nissin Chemical Co., Ltd.), Acetylenol (registered trademark) E00, E00P, E40, E100 (hereinabove, product names, manufactured by Kawaken Fine Chemicals Co., Ltd.), and the like.

The silicone-based surfactant is not particularly limited, and examples thereof preferably include a polysiloxane-based compound. The polysiloxane-based compound is not particularly limited, and examples thereof include polyether-modified organosiloxane. Examples of commercially available products of the polyether-modified organosiloxane include BYK (registered trademark)-306, BYK-307, BYK-333, BYK-341, BYK-345, BYK-346, and BYK-348 (hereinabove, product names, manufactured by BYK Chemie Japan Co., Ltd.), KF-351A, KF-352A, KF-353, KF-354L, KF-355A, KF-615A, KF-945, KF-640, KF-642, KF-643, KF-6020, X-22-4515, KF-6011, KF-6012, KF-6015, KF-6017 (hereinabove, product names, manufactured by Shin-Etsu Chemical Co., Ltd.), and the like.

The fluorine-based surfactant may be a fluorine-modified polymer and is not particularly limited, and examples thereof include BYK (registered trademark)-340 (product name, manufactured by Big Chemie Japan Co., Ltd.).

When the ink composition contains a surfactant, a sum of the content when a plurality of types of surfactants can be used is preferably 0.01% by mass or more and 3.0% by mass or less, more preferably 0.05% by mass or more and 2.0% by mass or less, still more preferably 0.1% by mass or more and 1.5% by mass or less, and particularly preferably 0.2% by mass or more and 1.0% by mass or less, with respect to the total mass of the ink.

1.4.4. Components Other than the Above Components

The white ink jet ink composition according to the present embodiment may contain an additive that can be usually used in ink jet ink such as a chelating agent, an antiseptic agent, an antifungal agent, an anti-rust agent such as benzotriazole, an antioxidant, an ultraviolet absorber, an oxygen absorber, and a dissolution aid as components other than the above components.

### 1.5. Relationship Between Components

### Material of Resin Particles and Hollow Resin Particles

In the white ink jet ink composition of the present embodiment, at least one of the resin particles and the hollow resin particles more preferably contains an anionic resin. Examples of the anionic resin include resins having an anionic group such as a carboxyl group, a sulfonic acid group, and a phosphoric acid group, and can be selected from acrylic acid-based resins, urethane-based resins, and the like.

When at least one of the resin particles and the hollow resin particles contains such an anionic resin, at least one of the resin particles and the hollow resin particles is more likely to aggregate in a case in which the white ink jet ink composition comes into contact with the cationic compound, and thus an image with even better image quality can be obtained.

### Relationship Between Glass Transition Temperatures

Regarding the glass transition temperature of the hollow resin particles and the glass transition temperature of the resin particles, an absolute value of the difference is more preferably 125° C. or higher, still more preferably 130° C. or higher, and particularly preferably 135° C. or higher. When the resin particles and the hollow resin particles are selected so as to have such a difference in the glass transition temperature, the color developing properties of the image can be further improved and the fabric followingness can be further improved.

### 1.6. Preparation Method and Physical Properties

### Preparation

The white ink jet ink composition according to the present embodiment is obtained by mixing each of the above-mentioned components in an optional order and filtering or the like depending on the necessity to remove impurities. As a method of mixing each component, a method of sequentially adding materials to a container equipped with a stirring device such as a mechanical stirrer and a magnetic stirrer and stirring and mixing is appropriately used. As the filtration method, centrifugal filtration, filter filtration and the like can be performed depending on the necessity.

### Surface Tension

In the present embodiment, a surface tension of the ink composition at 20° C. is preferably 20 mN/m or more and 40 mN/m or less, and more preferably 30 mN/m or more and 36 mN/m or less, from a viewpoint of the balance between print quality and reliability as an ink jet ink. By setting the surface tension within the above range, the ejection reliability is excellent in ink jet recording, and the ink easily wets and spreads uniformly on the recording medium at a time of adhesion to the recording medium, and the ink easily penetrates. With this, there is a case where the ink is easily fixed on the recording medium.

The surface tension can be measured by checking the surface tension when a platinum plate becomes wet with an ink under an environment of 20° C. using an automatic tensiometer CBVP-Z (product name, manufactured by Kyowa Interface Science Co., Ltd.). Examples of a technique of keeping the surface tension within the above range include appropriately adjusting the types of the above-mentioned organic solvent or surfactant, the addition amount of the organic solvent or surfactant and water, and the like.

### Viscosity

In addition, the viscosity of the ink at 20° C. is preferably 1.5 mPa·s or more and 15.0 mPa·s or less, more preferably 1.5 mPa·s or more and 5.0 mPa·s or less, and still more preferably 1.5 mPa·s or more and 3.6 mPa·s or less. When the viscosity of the ink at 20° C. is in the above range, there is a case where the ink is more easily fixed when it adheres to the recording medium, and the color developing properties are improved.

The viscosity can be measured using, for example, a viscoelasticity tester MCR-300 (product name, manufactured by Pysica). Examples of a technique of keeping the viscosity within the above range include appropriately adjusting the types of the above-mentioned organic solvent and surfactant, the addition amount of the organic solvent or surfactant and water, and the like.

### Young's Modulus of Dry Coating Film

The Young's modulus of the dry coating film of the white ink jet ink composition is preferably 20 MPa or less, more preferably 15 MPa or less, and still more preferably 10 MPa or less. When the Young's modulus of the dry coating film is such a value, in a case where the coating film is formed on a recording medium having elasticity, the coating film is more likely to follow the expansion and contraction of the recording medium. That is, when the Young's modulus of the dry coating film is preferably 20 MPa or less, an image having more favorable fabric followingness can be formed.

The Young's modulus of the coating film obtained by drying the white ink jet ink composition can be measured as follows.

A frame is provided with silicon rubber (thickness: 5 mm) on a flat plate of stainless steel (SUS), and 10 g of each ink composition or each coat composition prepared described above is put into an opening of 3 cm×19 cm, and dried in the atmosphere overnight. Then, heat treatment is performed at 160° C. for 15 minutes to obtain a coating film on the SUS. In addition, the coating film is peeled off from the SUS to obtain a coating film.

Regarding the obtained coating film, a stress-strain curve was measured under conditions of a test piece size width of 10 mm, height of 30 mm, and tensile speed of 100 mm/min using TENSILON universal testing machine (product name: RTG-1250 manufactured by A & D Co., Ltd.). Young's modulus [MPa] is obtained by linear regression between the stress-strain curve and a strain of 0.05% to 0.25%. A film thickness of the coating film required for the present measurement is obtained from actual measurement with a micrometer (product name “MDH-25M” manufactured by Mitutoyo Corporation).

### 1.7. Effect

According to the white ink jet ink composition of the present embodiment, the precipitation of the white color material can be favorably suppressed by using the hollow resin particles as the white color material. In addition, when hollow resin particles are used, the structure is easily broken during heating and drying and the color developing properties are likely to be deteriorated. However, by using the hollow resin particles having a glass transition temperature of 120° C. or higher, the deterioration of the color developing properties can be suppressed. On the other hand, when hollow resin particles having a high glass transition temperature are used, the elasticity of the dry coating film of the white ink jet ink composition may decrease and the followingness to the recording medium (cloth fabric) may decrease. However, according to the white ink jet ink composition, by further using resin particles having a glass transition temperature of 5° C. or lower as resin particles other than hollow resin particles, the followingness to the recording medium can be improved.

### 2. INK JET RECORDING METHOD

The ink jet recording method of the present embodiment includes a white ink adhesion step of ejecting the above-mentioned white ink jet ink composition from a recording head and adhering thereof to a recording medium.

According to the ink jet recording method of the present embodiment, by using hollow resin particles as the white color material, the precipitation of the white color material can be favorably suppressed. In addition, when hollow resin particles are used, the structure is easily broken during heating and drying and the color developing properties are likely to be deteriorated. However, by using the hollow resin particles having a glass transition temperature of 120° C. or higher, the deterioration of the color developing properties can be suppressed. In addition, according to this ink jet recording method, since resin particles having a glass transition temperature of 5° C. or lower, as resin particles other than hollow resin particles, are further used, it is possible to form an image having favorable followingness to a recording medium.

### 2.1. Recording Medium

The recording medium may have a recording surface that absorbs a liquid or may not have a recording surface that absorbs a liquid. Therefore, the recording medium is not particularly limited, and for example, paper, film, cloth, metal, glass, polymer, and the like can be used.

The material constituting the cloth is not particularly limited, and examples thereof include natural fibers such as cotton, linen, wool, and silk, synthetic fibers such as polypropylene, polyester, acetate, triacetate, polyamide, and polyurethane, and biodegradable fibers such as polylactic acid, and blended fibers of these may be used.

Examples of the form of the cloth include textile, garments or other clothing and accessories, and the like. The textile includes woven fabric, knitted fabric, non-woven fabric, and the like. Garments or other clothing and accessories include sewn T-shirts, handkerchiefs, scarves, towels, handbags, cloth bags, and furniture cloth such as curtains, sheets, bedspreads, and wallpaper as well as textile before and after cutting as parts to be sewn. Examples of these forms include a long roll-shaped one, a long one cut into a predetermined size, a product shape, and the like.

A basis weight of the cloth is not particularly limited, and may be 1.0 oz or more and 10.0 oz or less, preferably 2.0 oz or more and 9.0 oz or less, more preferably 3.0 oz or more and 8.0 oz or less, and still more preferably 4.0 oz or more and 7.0 oz or less. When the basis weight of the cloth is in such a range, favorable recording can be performed. In addition, in the ink jet recording method according to the present embodiment, a plurality of types of cloths having different basis weights can be applied, and favorable printing can be performed.

As the cloth, a cotton cloth pre-colored with a dye may be used. Examples of dyes in which the cloth is pre-colored include water-soluble dyes such as acid dyes and basic dyes, disperse dyes in which dispersants are used in combination, reactive dyes, and the like. When a cotton cloth is used as the cloth, it is preferable to use a reactive dye suitable for dyeing cotton.

Among these recording media, the recording medium is preferably a cloth, and preferably a cloth treated with a cationic compound. When recording is performed on a cloth using ink containing hollow resin particles, for example, even in a cloth treated with a component that aggregates the ink, there is a case where the hollow resin particles easily penetrate into the inside of the cloth and it is difficult to obtain sufficient color developing properties. However, since the ink jet recording method according to the present embodiment uses the above-mentioned white ink jet ink composition, excellent color developing properties can be obtained.

### 2.2. Ink Jet Recording Device

The ink jet recording method of the present embodiment can be carried out, for example, by filling an ink jet recording device provided with an ink accommodating body with a white ink jet ink composition. Hereinafter, an example of an ink jet recording device to which the white ink jet ink composition is applied will be described.

The ink jet recording device includes the above-mentioned white ink jet ink composition, an ink accommodating body accommodating the white ink jet ink composition, and a recording head for ejecting the white ink jet ink composition. In the ink jet recording device described below, the ink accommodating body has an ink fill that can be opened and closed for filling the white ink jet ink composition, but the ink jet recording device is not limited to this and any ink jet recording device may be used. That is, the ink jet recording device described below is an example of a device that can be used to carry out the ink jet recording method of the present embodiment.

The ink jet recording device will be described with reference to the drawings. The ink accommodating body is an ink tank of an ink jet printer (ink jet recording device) that performs recording (printing) of an image or the like on a medium by ejecting ink onto the medium. In addition, in the following description, the ink jet recording device may be simply referred to as a recording device, and the white ink jet ink composition may be simply referred to as ink.

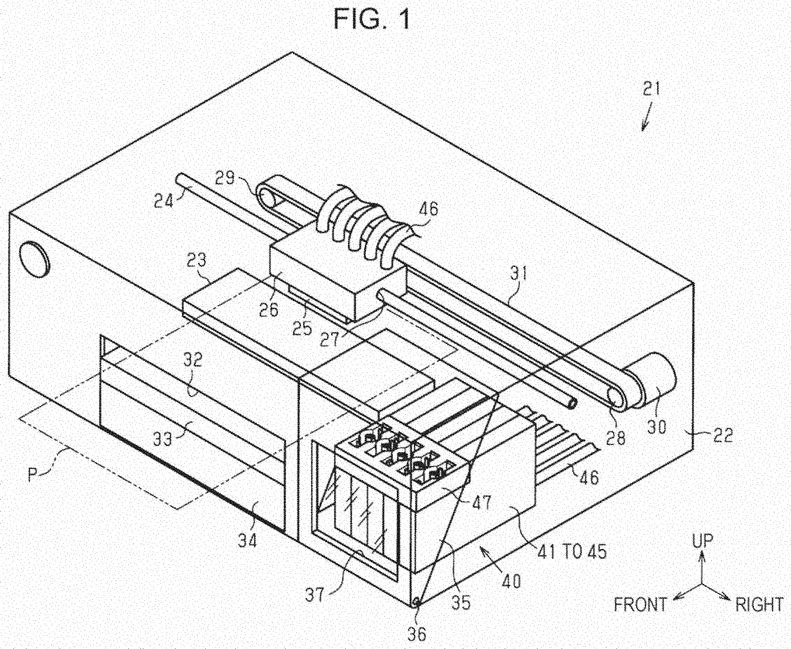

As shown in FIG. 1, a recording device 21 includes a rectangular parallelepiped housing 22 having a left-right direction as a longitudinal direction. FIG. 1 simply shows the recording device 21 in which the inside of the housing 22 is in a state of being seen through. A support base 23 having a left-right direction as a longitudinal direction is provided at a lower portion close to a rear side in the housing 22 so that an upper surface thereof is substantially horizontal. A paper P, which is an example of the medium, is supported on the upper surface of the support base 23 and is transported toward the front in the transport direction. In addition, a guide shaft 24 extending in the left-right direction is erected at an upper position of the support base 23 in the housing 22, and a carriage 26 provided with a recording head 25 for ejecting ink on a lower surface side of the guide shaft 24 is supported. That is, the carriage 26 is supported so as to be reciprocally movable in the left-right direction with respect to the guide shaft 24 in a state in which the guide shaft 24 is inserted into a support hole 27 penetrating in the left-right direction.

In addition, a drive pulley 28 and a driven pulley 29 are rotatably supported at positions in the housing 22 near both ends of the guide shaft 24. An output shaft of a carriage motor 30 is coupled to the drive pulley 28, and an endless timing belt 31 partially coupled to the carriage 26 is wound between the drive pulley 28 and the driven pulley 29. Then, when the carriage 26 is guided by the guide shaft 24 via the timing belt 31 and reciprocates along the left-right direction which is a scanning direction with respect to the paper P by the drive of the carriage motor 30, ink is ejected from the recording head 25 on the lower surface side of the carriage 26 to the paper P transported forward on the support base 23.

In addition, as shown in FIG. 1, a rectangular discharge port 32 for discharging on a front side the paper P on which recording is performed by ejection of ink from the recording head 25 when the ink is transported on the support base 23 in the housing 22 is open at a position which is the front side of the support base 23 on the front surface side of the housing 22. The discharge port 32 is provided with a rectangular plate-shaped discharge tray 33 capable of supporting the paper P discharged from the housing 22 so as to be able to appear and disappear forward in the discharge direction. In addition, in the discharge port 32, a paper feed cassette 34 capable of accommodating a plurality of sheets of paper P used for recording in a stacked state is mounted on a lower side of the discharge tray 33 so as to be freely inserted and removed in the front-rear direction.

In addition, as shown in FIG. 1, an opening/closing door 35 in which a front surface and an upper surface are rectangular and a right side surface forms a right triangle shape is provided so as to be able to open and close in a front-rear direction having a rotation shaft 36 as a rotation center in a left-right direction provided at a lower end, at a position which is an end portion side in the left-right direction from the discharge port 32 on the front surface of the housing 22 (right end portion side in FIG. 1). A window portion 37 made of a rectangular transparent member is formed on the front surface of the opening/closing door 35, and the user can visually recognize the inside of the housing 22 (particularly, a back side of the front surface of the opening/closing door 35) in a state of the opening/closing door 35 being closed.

In the housing 22 of the recording device 21, an ink supply unit 40 that supplies ink to the recording head 25 is accommodated at a position which is a back side of the opening/closing door 35, that is, a position which is close to a front surface and close to an end portion (in this case, closer to a right end portion side). The ink supply unit 40 is a structure that includes a plurality of (five in the present embodiment) ink accommodating bodies 41 to 45 and can be integrally handled, and as will be described later, and ink can be replenished in each of ink accommodating bodies 41 to 45.

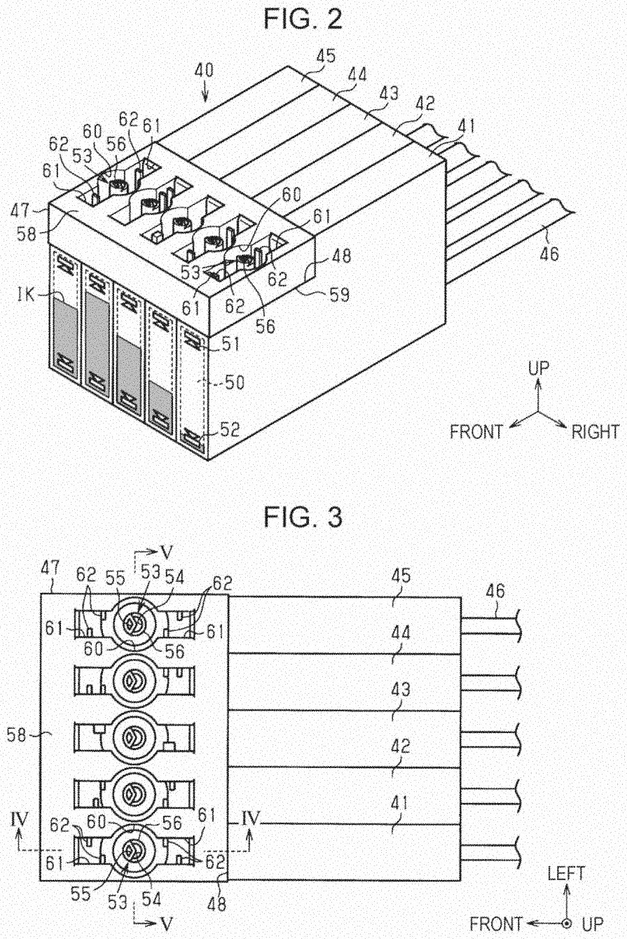

As shown in FIGS. 2 and 3, the ink supply unit 40 is configured to include five ink accommodating bodies 41 to 45 having a deformed box shape long in the front-rear direction, five ink supply tubes 46 drawn from a rear surface side of each of the ink accommodating bodies 41 to 45, and a rectangular parallelepiped ink replenishment adaptor 47 that can be combined in a state in which the ink accommodating bodies 41 to 45 are collectively assembled. The ink replenishment adaptor 47 is integrated with the ink accommodating bodies 41 to 45 by being combined in a step portion 48 formed by being cut off in an upper front half portion of all the ink accommodating bodies 41 to 45 in a state in which all the ink accommodating bodies 41 to 45 are arranged side by side in a thickness direction as the left-right direction. As shown in FIG. 1, the ink supply tubes 46 drawn out from the ink accommodating bodies 41 to 45 are coupled to an ink flow path (not shown) formed in the carriage 26, and are coupled to the recording head 25 via the ink flow path. The ink replenishment adaptor 47 may form a part of the housing 22 that covers the ink accommodating bodies 41 to 45, or may be integrally formed with the ink accommodating bodies 41 to 45.

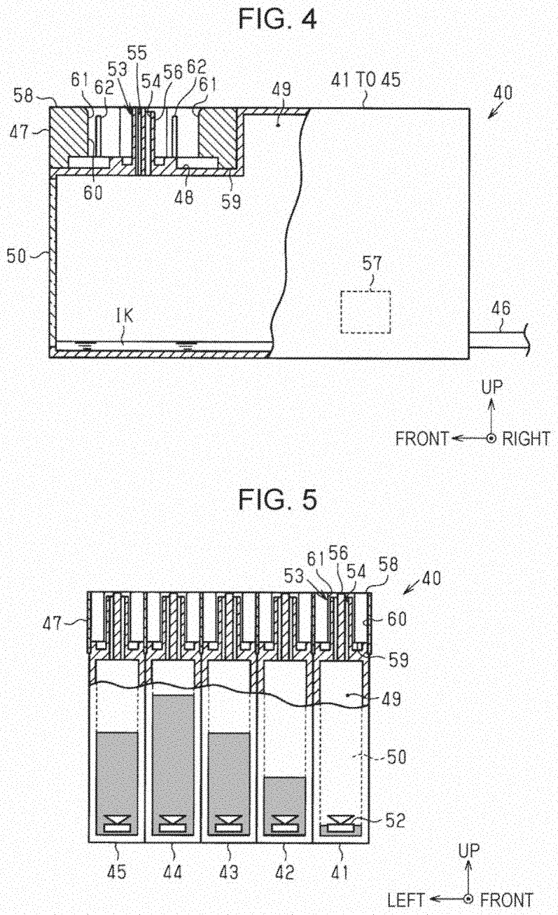

As shown in FIGS. 4 and 5, the ink accommodating bodies 41 to 45 have an ink storage chamber 49 in which an ink composition IK can be stored. In a case of the present embodiment, black ink is stored in the ink storage chamber 49 of the ink accommodating body 41 positioned at a right end in the side-by-side direction. Then, color (cyan, magenta, yellow, and the like) ink other than black is stored in the ink storage chambers 49 of the other ink accommodating bodies 42 to 45 arranged on a left side from the ink accommodating body 41 at the right end in the side-by-side direction. In addition, a visual recognition portion 50 formed of a transparent resin that makes a liquid level of the ink composition IK in the ink storage chamber 49 visible is provided on a front wall portion that is visually recognizable via a window portion 37 on the front surface of the housing 22 in the ink accommodating bodies 41 to 45. Then, in the visual recognition portion 50, an upper limit mark 51 indicating a guideline of the upper limit (an example of a guideline for an amount of ink that can be filled without spilling the ink from an ink inlet 53) and a lower limit mark 52 indicating a guideline for the lower limit (for example, a guideline for promoting ink replenishment) of a liquid level of the ink composition IK in stored in the ink storage chamber 49 are described.

As shown in FIG. 4, an openable/closable ink inlet 53 (ink fill) that allows ink to flow into the ink storage chamber 49 from the outside is provided on an upper side of a horizontal portion of the step portion 48 in the ink accommodating bodies 41 to 45. The ink inlet 53 includes a needle 56 having flow paths 54, 55 communicating the inside and the outside of the ink storage chamber 49 and extending vertically upward. The flow paths 54, 55 of the needle 56 are formed of two flow paths 54, 55 in which each of tip openings are arranged side by side in a radial direction centering on the needle 56, and one (on a right side in FIG. 4) flow path 54 of the two flow paths 54, 55 has a lower tip opening height and a larger cross-sectional area of the flow path than the other (on a left side in FIG. 4) flow path 55. A remaining amount sensor 57 for detecting the remaining amount of the ink composition IK in the ink storage chamber 49 is provided in a lower portion close to the rear side in the ink storage chamber 49. The remaining amount sensor 57 may not be provided.

As shown in FIGS. 2 to 5, the ink replenishment adaptor 47 has a horizontal surface along a direction in which an upper surface 58 thereof is orthogonal (intersects) to the extending direction of the needle 56, and a through hole 60 penetrating a lower surface 59 in the vertical direction is formed as an ink inlet forming portion on the upper surface 58. The through hole 60 is formed of a circular hole-shaped ink inlet 53 in which the needle 56 is arranged in the center, and a pair of front and rear rectangular holes coupled to the front and rear of the ink inlet 53, and the lower side openings thereof are blocked by the horizontal portion of the step portion 48 in which the needle 56 is provided projecting upward in the ink accommodating bodies 41 to 45.

Therefore, in the through hole 60, in a region outside the ink inlet 53 in the radial direction centered on the ink inlet 53, recesses are deeply formed in the vertical lower direction as a depth direction such that a pair of front and rear recesses 61 that open on the upper side of the needle 56 in the extending direction is point-symmetrical centering the ink inlet 53 by the pair of front and rear rectangular holes of which lower side opening is blocked. That is, in a region outside the ink inlet 53 including the needle 56 in the ink replenishment adaptor 47 integrated with the ink accommodating bodies 41 to 45, a plurality of recesses 61 (in this case, two recesses paired with each other in the front and rear) point-symmetrical centering the ink inlet 53 are formed. In this case, the tip of the needle 56 arranged at the center of the circular hole-shaped ink inlet 53 is positioned closer to the ink storage chamber 49 than the upper surface 58 of the ink replenishment adaptor 47 which is an opening edge of the through hole 60 including the ink inlet 53 and the recess 61. That is, the upper surface 58 of the ink replenishment adaptor 47 extends in a direction that intersects the direction in which the needle 56 extends at a position outside the tip of the needle 56 in the extending direction of the needle 56. On the other hand, the lower surface 59 of the ink replenishment adaptor 47 functions as a tank engaging portion that collectively engages the plurality of ink accommodating bodies 41 to 45 arranged side by side in the left-right direction from the upper side.

In addition, in the upper surface 58 of the ink replenishment adaptor 47, a peripheral portion of the upper opening edge of each through hole 60 is colored in a specific color. That is, the ink is colored in the same color as the ink stored in the ink storage chambers 49 of the ink accommodating bodies 41 to 45 into which the ink flows through the ink inlet 53 of the through hole 60. In this point, the peripheral portion of the upper opening edge of each through hole 60 in the ink replenishment adaptor 47 functions as a first portion to show to the outside information related to the ink stored in the ink accommodating bodies 41 to 45 in which the ink inlet 53 of the through hole 60 and the ink storage chamber 49 communicate with each other. Incidentally, the ink stored in the ink accommodating bodies 41 to 45 is not particularly limited, but when the ink accommodating body supplied from the ink accommodating bodies accommodating the ink composition of the present embodiment is the ink accommodating body 41, since black ink of black or gray is stored, the peripheral portion of the upper side opening of the through hole 60 in which the ink inlet 53 communicating with the ink storage chamber 49 of the ink accommodating body 41 is arranged is colored in black or gray.

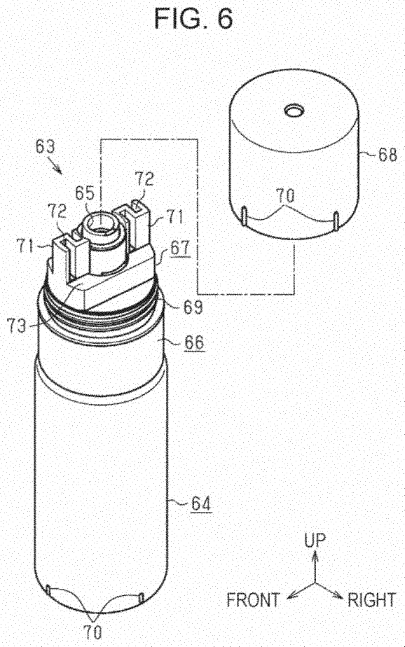

In addition, on an inner surface of the recess 61 (specifically, the inner surface along the vertical direction), a first uneven portion (first key structure portion) 62 having a characteristic uneven shape in the horizontal direction is provided so as to extend along a depth direction (in other words, direction of the central axis of the ink inlet 53) of the recess 61 at a position which is a bottom surface side (that is, horizontal portion side of the step portion 48) than the upper opening edge of the recess 61. As shown in FIGS. 2 and 3, the first uneven portion 62 is provided for each ink inlet 53 of a plurality of (five in the present embodiment) ink accommodating bodies 41 to 45. Therefore, in the ink replenishment adaptor 47, a first uneven portion 62 different from the first uneven portion 62 provided on the inner surface of the recess 61 of the other through hole 60 for each through hole 60 is formed on the rectangular recess 61 in each through hole 60 formed at each of positions corresponding to each of the ink accommodating bodies 41 to 45 in the vertical direction. That is, these first uneven portions 62 function as an identification portion that enables identification of an ink bottle 63 (refer to FIG. 6 and the like) having an ink outlet 65 (refer to FIG. 6 and the like) coupled to the ink inlet 53 in the through hole 60 in which the first uneven portion 62 is formed. The “position which is the bottom surface side of the upper opening edge of the recess 61” means that the position may be slightly recessed toward the bottom surface side of the opening edge.

Therefore, next, the ink bottle 63 will be described as an ink replenishment container that constitutes an ink replenishment system together with the ink accommodating bodies 41 to 45 and replenishes ink to the ink accommodating bodies 41 to 45 having a low ink remaining amount. The ink bottle 63 accommodates the above-mentioned white ink jet ink composition.

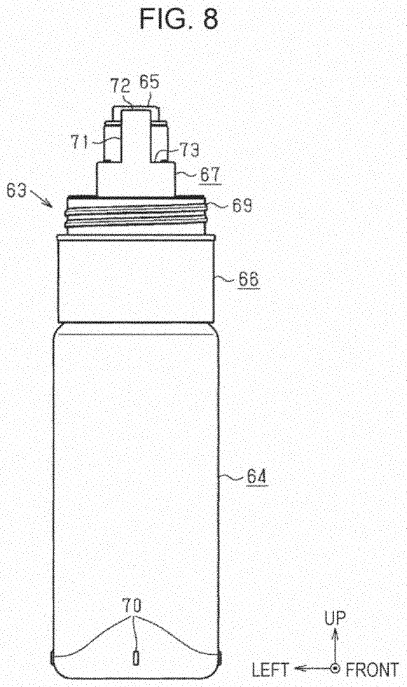

As shown in FIGS. 6 to 8, the ink bottle 63 includes a cylindrical container main body portion 64, which is the main body thereof, an ink outlet forming portion 66 provided at a tip portion of the container main body portion 64, in which the ink outlet 65, which allows ink from the inside of the ink bottle 63 to flow out, having an opening formed at the tip thereof, and a container adding portion 67 added to the ink outlet forming portion 66 so as to surround the ink outlet 65. The ink outlet 65 of the ink outlet forming portion 66 is covered with a bottomed cylindrical cap 68 including the container adding portion 67 around thereof, and is concealed from the outside, when the ink bottle 63 is stored. That is, while a male screw portion 69 is formed on an outer peripheral surface of a lower end portion having a cylindrical shape of the container adding portion 67, a female screw portion (not shown) is formed on an inner peripheral surface of the cap 68, and by screwing the female screw portion of the cap 68 into the male screw portion 69 of the container adding portion 67, the cap 68 is attached to the tip portion of the ink bottle 63 so as to cover the ink outlet 65.

The entire outer surface of the container adding portion 67 is colored in a specific color. That is, the outer surface thereof is colored in the same color as the color of the ink accommodated in the container main body portion 64 to which the container adding portion 67 is added. Incidentally, the outer surface of the container adding portion 67 in the ink bottle 63 accommodating black or gray ink is colored in black or gray. In addition, a plurality of (four in the present embodiment) protrusions 70 is formed at equal angle intervals (as an example, 90-degree intervals) on the outer peripheral surfaces of each of base end portions of the container main body portion 64 and the cap 68. Incidentally, these protrusions 70 are formed to prevent the ink bottle 63 having a cylindrical shape from rolling. In addition, for example, the container main body portion 64 of the ink bottle 63 accommodating black ink may be formed thicker than the container main body portion 64 of the ink bottle 63 accommodating inks of other colors. In this case, the ink outlet forming portion 66 may have the same thickness and shape as those for black ink and those for inks of other colors.

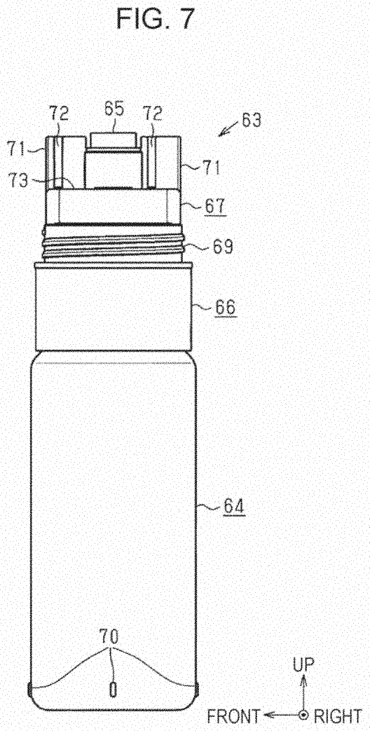

In addition, as shown in FIGS. 6 to 8, in an upper portion than the cylindrical lower end portion in which the male screw portion 69 is formed on the outer peripheral surface of the container adding portion 67, in a region outside the ink outlet 65 in a radial direction centering the ink outlet 65, there is formed a projection 71 that protrudes upward in a direction opposite to the container main body portion 64 than the ink outlet 65 in a direction of the central axis of the ink outlet 65. When the tip of the needle 56 on the ink inlet 53 side is inserted into the ink outlet 65, the projection 71 functions as a second fitting portion that allows the recess 61 of the upper surface 58 of the ink replenishment adaptor 47 to be fitted as a first fitting portion, and is provided so as to form a pair by pinching the ink outlet 65 from the front and rear, similarly to the pair of recesses 61 pinching the ink inlet 53 from the front and rear. As shown in FIGS. 6 and 7, the projection 71 is formed on an inner side than the outer peripheral surface of the container main body portion 64 in the radial direction centering the ink outlet 65 in the ink bottle 63.

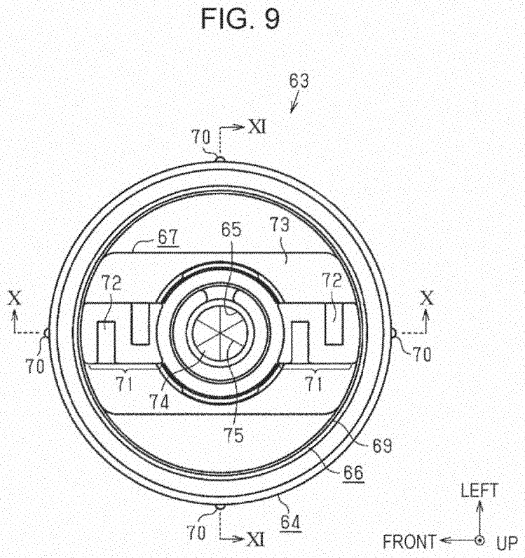

As shown in FIGS. 6 and 9, on the outer surface of each projection 71 (the left and right side surfaces in FIGS. 6 and 9), a second uneven portion (second key structure portion) 72 capable of being engaged with the first uneven portion (first key structure portion) 62 formed on the inner surface of the recess 61 of the ink replenishment adaptor 47 is formed. The second uneven portion 72 is provided so as to extend along a protruding direction (in other words, direction of the central axis of the ink outlet 65) of the projection 71, the projection 71 is fitted into the recess 61, and when the second uneven portion 72 is engaged with the first uneven portion 62, the ink outlet 65 of the ink bottle 63 is coupled to the ink inlet 53 on the ink accommodating bodies 41 to 45 side.

In addition, a planar positioning portion 73 orthogonal to (intersects) the central axis of the ink outlet 65 is provided between the cylindrical lower end portion in which the male screw portion 69 of the container adding portion 67 is formed and the projection 71 in which the second uneven portion 72 is formed so as to be positioned outside the ink outlet 65 in the radial direction when the ink outlet 65 is viewed in the direction of the central axis thereof. That is, the positioning portion 73 constitutes a part of the outer surface of the container adding portion 67 which is a part of the outer surface of the ink bottle 63, and is provided at a position which is on the container main body portion 64 than the tip of the projection 71 in the direction of the central axis of the ink outlet 65. Since the positioning portion 73 is provided in the container adding portion 67 added to the ink outlet forming portion 66 in the ink bottle 63, it can be said that the positioning portion 73 has a structure different from that of the ink outlet forming portion 66 and has a structure provided outside the ink outlet forming portion 66.

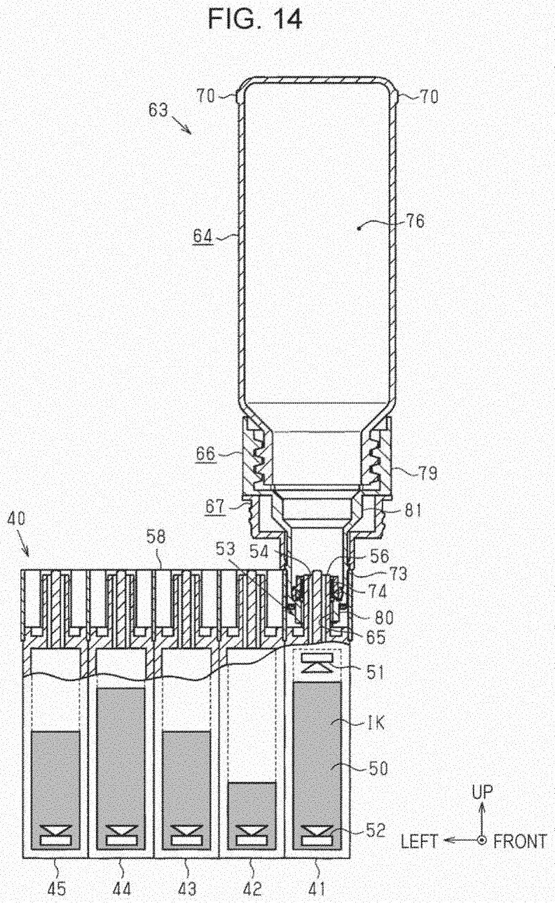

In addition, as shown in FIG. 9, in the ink outlet 65 formed in the ink outlet forming portion 66, a valve 74 made of an elastic member such as a silicone film that seals the ink outlet 65 so as to be opened and closed is provided. The valve 74 is provided at a position in which the positioning portion 73 is on the container main body portion 64 side of the positioning portion 73 in the direction of the central axis of the ink outlet 65 (for example, refer to FIG. 14). The valve 74 is provided with a plurality of (three in the present embodiment) slits 75 that intersect at equal angle intervals (as an example, 120-degree intervals) with the center as an intersection, and these slits 75 are configured to open the valve by being pushed inward from the outside of the ink outlet 65. That is, when the tip of the needle 56 on the ink inlet 53 side is inserted into the ink outlet 65, the normally closed valve 74 is expanded inward by the tip of the needle 56 to open the valve.

At this time, the positioning portion 73 abuts on the upper surface 58 of the ink replenishment adaptor 47 in which the through hole 60 including the ink inlet 53 and the recess 61 is formed outside the ink outlet 65 in the radial direction, and the valve 74 is positioned with respect to the ink accommodating bodies 41 to 45 in the direction of the central axis of the ink outlet 65. In this point, the upper surface 58 of the ink replenishment adaptor 47 is a part of the ink accommodating bodies 41 to 45 side to which the positioning portion 73 of the ink bottle 63 abuts when the valve 74 of the ink outlet 65 of the ink bottle 63 for ink replenishment to the ink accommodating bodies 41 to 45, and functions as a receiving surface for receiving the planar positioning portion 73.

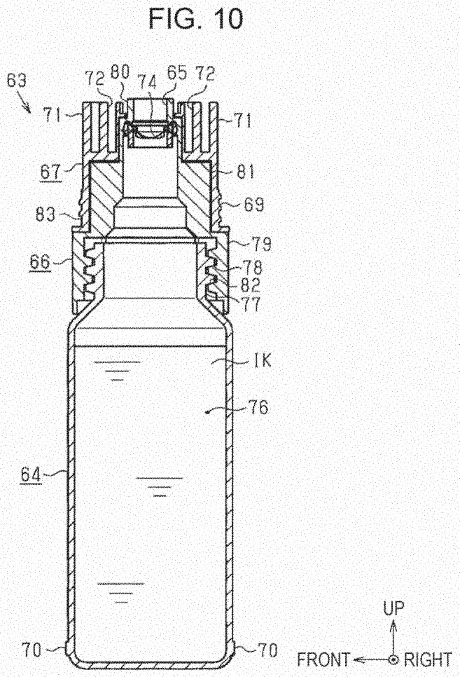

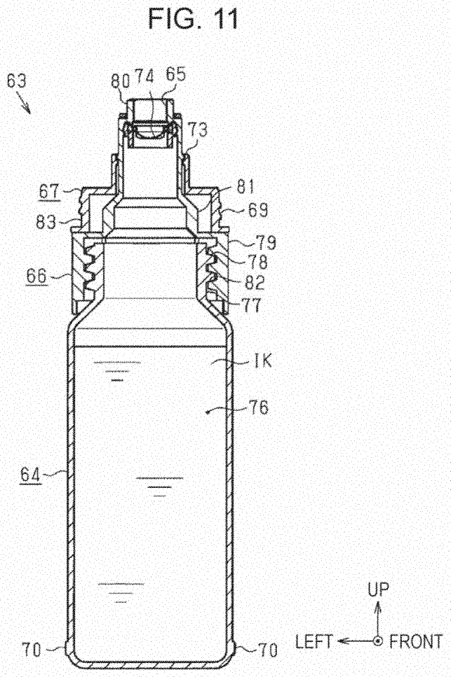

As shown in FIGS. 10 and 11, the container main body portion 64 in the ink bottle 63 is a bottle-shaped member having an ink accommodating chamber 76 capable of accommodating the ink composition IK inside, and is a male screw portion 78 is formed on an outer peripheral surface of a neck portion 77 of the upper end portion thereof. On the other hand, the ink outlet forming portion 66 provided at the upper end portion of the container main body portion 64 has a large diameter portion 79 positioned on the outer peripheral side of the neck portion 77 of the container main body portion 64, a small diameter portion 80 forming the ink outlet 65 at a position farthest from the container main body portion 64, and an intermediate portion 81 coupling the large diameter portion 79 and the small diameter portion 80. Then, by screwing the female screw portion 82 formed on the inner peripheral surface of the large diameter portion 79 into the male screw portion 78 formed on the outer peripheral surface of the neck portion 77 of the container main body portion 64, the ink outlet forming portion 66 is attached to the upper end portion of the container main body portion 64.

In addition, in the container adding portion 67 added to the ink outlet forming portion 66 of the ink bottle 63 so as to surround the ink outlet 65, a cylindrical lower end portion in which the male screw portion 69 is formed on the outer peripheral surface thereof constitutes a joint portion 83 joined the lower end surface thereof to the upper end surface of the large diameter portion 79 of the ink outlet forming portion 66. In the joint portion 83, surface regions of the inner peripheral surface facing each other in the front-rear direction are in surface contact with the outer surface on the front side and the outer surface on the rear side of the intermediate portion 81 of the ink outlet forming portion 66, and is joined to the large diameter portion 79 of the ink outlet forming portion 66.

Next, the action of the ink replenishment system configured as described above will be described below, focusing on the action at the time of replenishing ink to the ink accommodating bodies 41 to 45 of the ink supply unit 40 using the ink bottle 63.

As a premise, as shown in FIG. 2, since the liquid level height of the ink in the ink accommodating body 41 of the black ink positioned on the rightmost side of the plurality of the ink accommodating bodies 41 to 45 arranged side by side is lowered to the height of the lower limit mark 52 denoted in a lower portion of the visual recognition portion 50, a case in which ink is replenished to the ink accommodating body 41 will be described below. In addition, the ink bottle 63 used for ink replenishment sufficiently accommodates black ink, and the cap 68 is removed from the ink bottle 63 in advance. In addition, a shape of the second uneven portion 72 formed on the outer surface of the projection 71 of the ink bottle 63 is coincident with a shape of the first uneven portion 62 formed on the inner surface of the recess 61 positioned on the front and rear of the ink inlet 53 to the ink accommodating body 41, and can be engaged in accordance with the insertion of the projection 71 into the recess 61.

When performing ink replenishment to the ink accommodating body 41, the user first sets the opening/closing door 35 of the housing 22 from a closed state as shown in FIG. 1 to an open state by rotating the opening/closing door 35 forward around the rotation shaft 36 as a center. Then, in the ink supply unit 40, the upper surface 58 of the ink replenishment adaptor 47 in which the ink inlet 53 into the ink accommodating bodies 41 to 45 is formed is exposed to the outside of the housing 22, and the user can couple the ink outlet 65 of the ink bottle 63 to a desired ink inlet 53 from above.

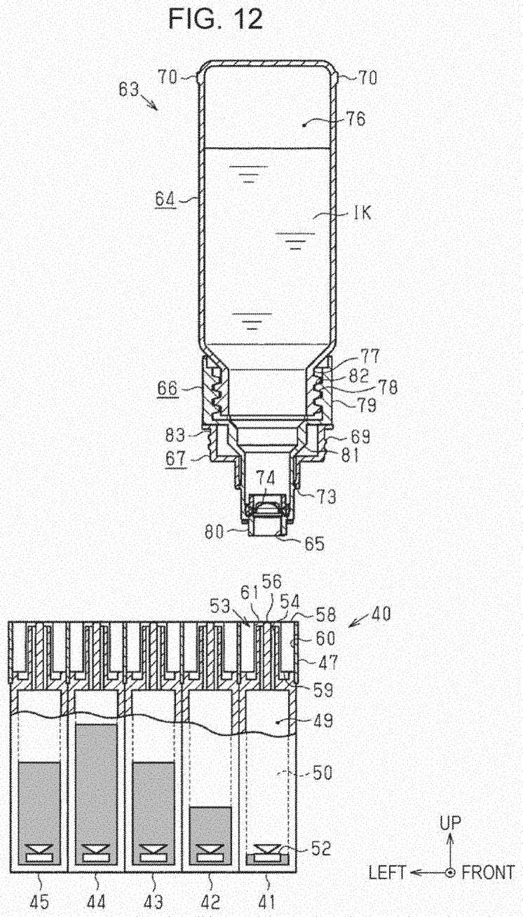

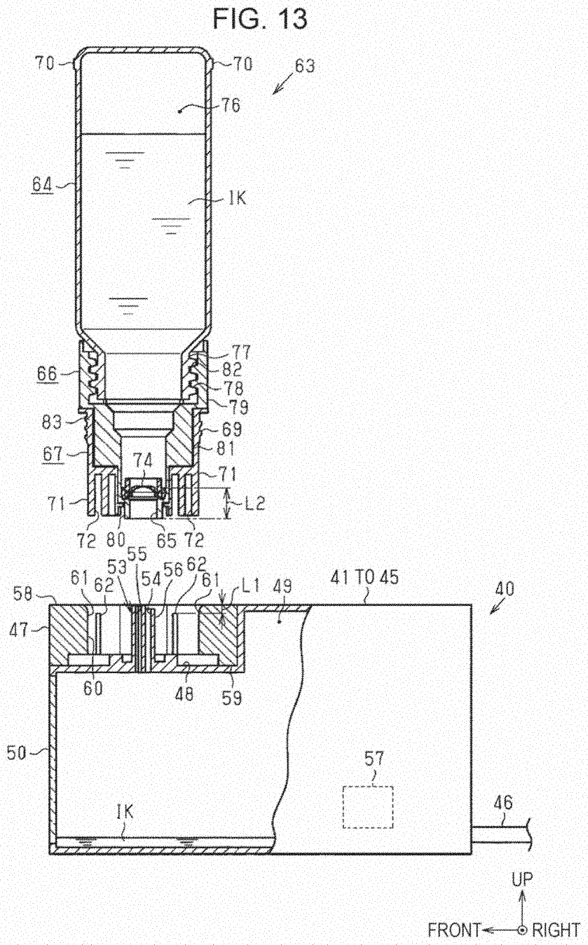

Therefore, as shown in FIGS. 12 and 13, the user turns the ink bottle 63 accommodating the ink composition used for ink replenishment upside down, and the ink outlet 65 is held so as to be positioned the above the rightmost through hole 60 in the ink replenishment adaptor 47. That is, the central axis line of the ink outlet 65 of the ink bottle 63 is aligned with the central axis line of the ink inlet 53 of the ink accommodating body 41 to be replenished with ink. At this time, the user can compare the color (second portion) colored in the container adding portion 67 of the ink bottle 63 held in his/her hand and the color (first portion) colored in the upper opening edge of the through hole 60 provided with the ink inlet 53 of the ink accommodating body 41 to be replenished with ink at this time. Then, when each color is the same (in this case, blacks), it is confirmed that the ink bottle 63 suitable for the ink replenishment this time is held in the hand, and the subsequent work in the ink replenishment is carried out.

Then, the ink bottle 63 is lowered from the state shown in FIGS. 12 and 13, and the projection 71 of the ink bottle 63 is inserted into the recess 61 of the ink replenishment adaptor 47 integrated with the ink accommodating body 41. Then, by realizing the inserted state of the projection 71 with respect to the recess 61, a coincident state of the central axis line of the ink outlet 65 with respect to the central axis line of the ink inlet 53 is ensured. In this case, since the recess 61 is in a position point-symmetrical with respect to the needle 56 which is the center of the ink inlet 53, the projection 71 can be inserted into any of the recess 61. Therefore, it is not necessary to rotate the ink bottle 63 many times around the central axis line of the ink outlet 65 to confirm a suitable positional relationship between the recess 61 and the projection 71, and the user can use easily perform insertion work of the projection 71 with respect to the recess 61.

However, at this point, only a small portion of the projection 71 is inserted into the recess 61, and the tip of the needle 56 positioned at the center of the ink inlet 53 is also inserted into the opening of the ink outlet 65 slightly protruding from the tip of the projection 71 but does not reach the valve 74 positioned in an inner part of the ink outlet 65. The reason is that, as shown in FIG. 13, a distance L2 between the tip of the projection 71 and the valve 74 in the ink outlet 65 is longer than a distance L1 between the upper surface 58 of the ink replenishment adaptor 47 in which the opening edge of the recess 61 is positioned and an upper end of the first uneven portion 62 in the recess 61. Therefore, when the projection 71 is further inserted downward in a depth direction of the recess 61 from the state, the second uneven portion 72 on the outer surface of the projection 71 is engaged with the first uneven portion 62 on the inner surface of the recess 61. Then, while maintaining the engaged state, when the projection 71 is further inserted toward the bottom surface side in the depth direction of the recess 61, the tip of the needle 56 of the ink inlet 53 reaches a position of the valve 74 of the ink outlet 65, and the valve 74 is opened.

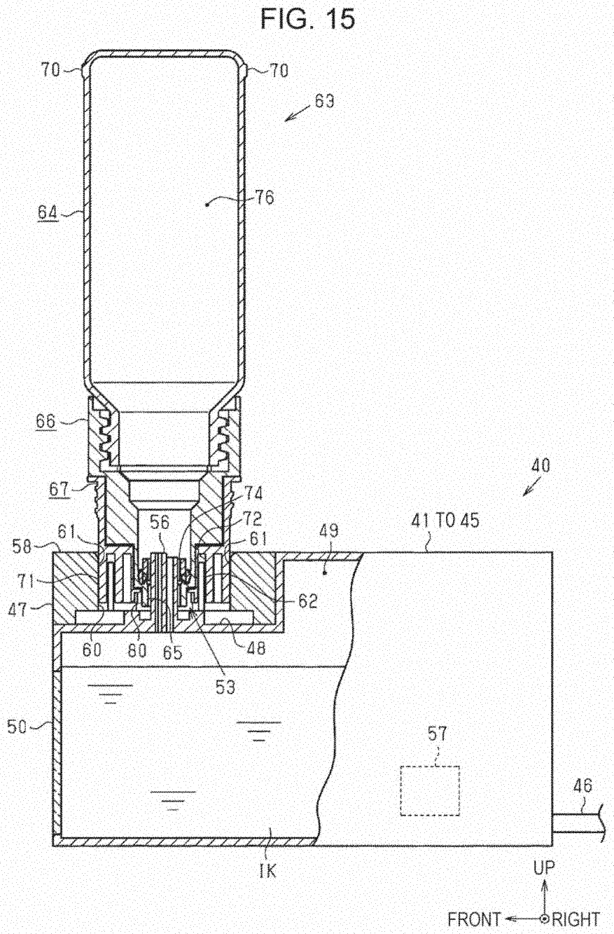

That is, as shown in FIGS. 14 and 15, the tip of the needle 56 pushes the slit 75 upward from below (that is, from the outside to the inside of the ink outlet 65) with respect to the valve 74, and thereby the valve 74 comes into an opened state. As a result, the ink outlet 65 of the ink bottle 63 and the needle 56 of the ink inlet 53 of the ink accommodating body 41 are coupled to each other, and replenishment of the ink composition from the inside of the ink bottle 63 into the ink accommodating body 41 is performed. At this time, among the two flow paths 54 and 55 of the needle 56 of the ink inlet 53, one flow path in which the valve 74 is closed and the tip opening first touches the ink flowed out from the ink outlet 65 functions as an ink flow path through which ink flows, and the other flow path functions as an air flow path through which air flows. For example, when the user tries to couple the ink outlet 65 to the ink inlet 53 in a state of the ink bottle 63 being tilted, the flow path that becomes an ink flow path among the two flow paths 54 and 55 due to the difference in the tilting direction also changes.

When the second uneven portion 72 is not engaged with the first uneven portion 62 after the projection 71 is inserted into the recess 61, at that point, the user can recognize that the ink bottle 63 of a color other than black is mistakenly attempted to be inserted. In this case, when the upper end of the first uneven portion 62 is positioned at the same height as that of the opening edge of the recess 61, the engagement of the second uneven portion 72 with the first uneven portion 62 is rejected, and the insertion of the projection 71 into the recess 61 is also rejected. Therefore, the user may try to insert the projection 71 into the recess 61 many times and waste work time unnecessarily. In this point, in the present embodiment, since the height of the first uneven portion 62 is lower than the opening edge of the recess 61, the projection 71 is easily guided to the bottom surface side in the depth direction of the recess 61 when inserted into the recess 61 and it is possible to prevent unnecessary lengthening of work time.

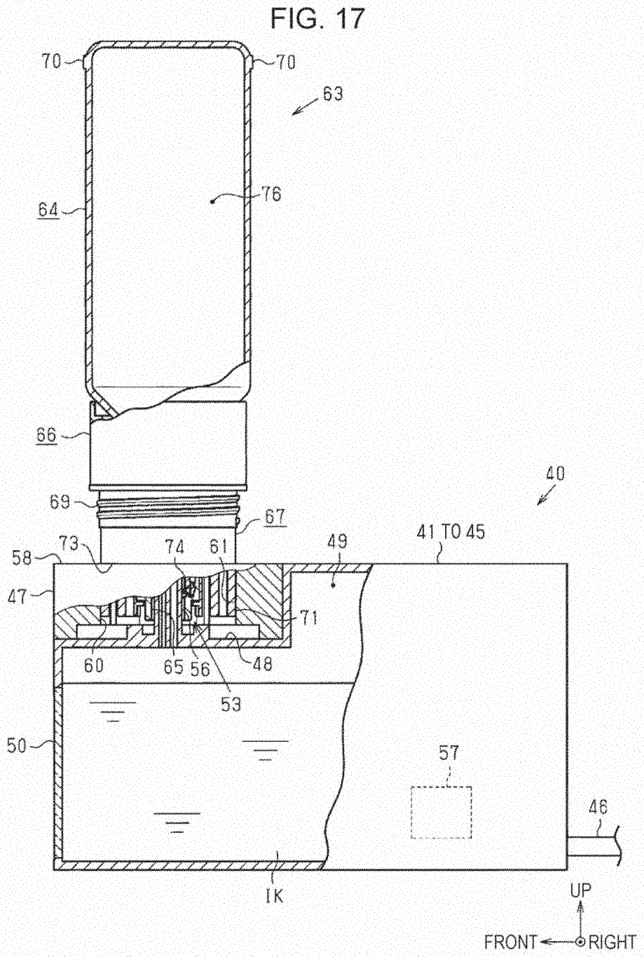

In addition, as shown in FIGS. 14, 16, and 17, when the needle 56 of the ink inlet 53 on the ink accommodating body 41 opens the valve 74 in the ink outlet 65 of the ink bottle 63, in the ink bottle 63, the positioning portion 73 abuts the upper surface 58 of the ink replenishment adaptor 47 which is a part of the ink accommodating body 41 side. That is, in the ink bottle 63, due to the abutment of the positioning portion 73 and the upper surface 58 of the ink replenishment adaptor 47, the valve 74 is opened in a state of being positioned in a direction of the central axis of the ink outlet 65 with respect to the needle 56 on the ink accommodating body 41 side.

In addition, at the time, since the positioning portion 73 is positioned outside the ink outlet 65 in the radial direction, the ink bottle 63 is stably held in a posture in which the ink outlet 65 is coupled to the ink inlet 53. In addition, as shown in FIGS. 14 and 15, when the positioning portion 73 of the ink bottle 63 abuts with the upper surface 58 of the ink replenishment adaptor 47, a gap is present between the bottom surface of the ink inlet 53 at which a base end of the needle 56 is positioned in the ink inlet 53 and the tip of the ink outlet 65 of the ink bottle 63. Therefore, ink tends to accumulate on the bottom surface of the ink inlet 53 in which the base end of the needle 56 is positioned, but it is also possible to prevent the accumulated ink from adhering to the tip of the ink outlet 65 and contaminating the ink bottle 63.

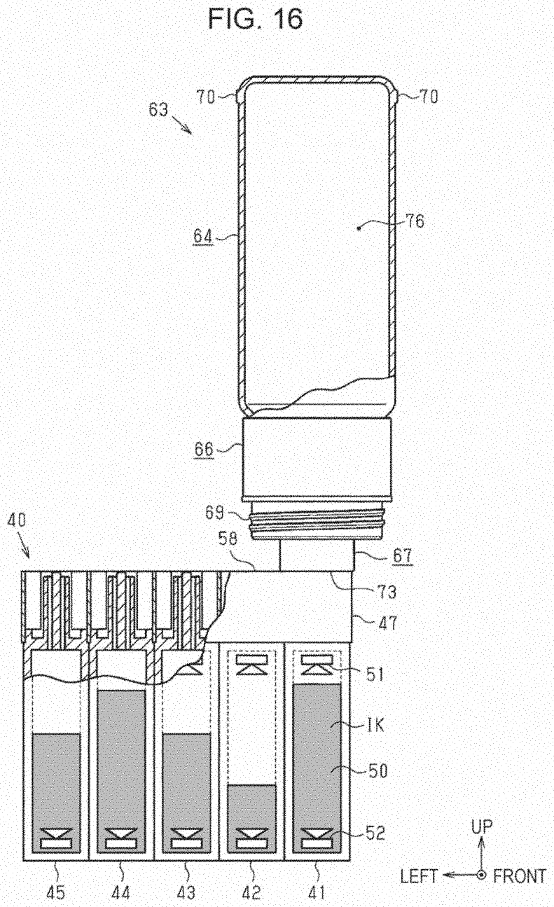

Then, as shown in FIGS. 14 and 16, when the ink replenishment from the ink bottle 63 to the ink accommodating body 41 is completed, in a case where the liquid level height of the ink in the ink accommodating body 41 is still lower than the upper limit mark 51 of the visual recognition portion 50, ink replenishment further supplied to the upper limit mark 51 may be performed using the same black ink bottle 63. The ink replenishment work as described above is similarly performed for the ink accommodating bodies 42 to 45 of other colors other than the ink accommodating body 41 of the ink composition (black or gray ink composition).

An ink jet recording method of the present embodiment can be easily carried out by ejecting the above-mentioned white ink jet ink composition from the recording head of the above-mentioned ink jet recording device and adhering thereof to a recording medium.

A step of adhering the white ink jet ink composition to the recording medium can be performed using the above-mentioned ink jet recording device. That is, a step of adhering the white ink jet ink composition to the recording medium can be performed by filling the recording head with the white ink jet ink composition so as to be ejected from a predetermined nozzle, and ejecting thereof to the recording medium at a predetermined timing in the state.

### 2.3. Cationic Compound Treatment

The ink jet recording method may include a step of treating a cloth with a cationic compound. The treatment method is not particularly limited, but the cloth can be treated with the cationic compound by applying a pretreatment agent containing a cationic compound to the cloth and drying thereof. In addition, the pretreatment agent may be adhered by the above-mentioned ink jet recording device.

### Pretreatment Agent

When a pretreatment agent is used, the pretreatment agent may contain a cationic compound. The pretreatment agent may contain resin particles, an organic solvent, water, and the like that can be contained in the above-mentioned white ink jet ink composition.

The cationic compound has a function of aggregating components in the ink composition. Therefore, when the ink composition is adhered to the cloth to which the pretreatment agent is adhered, the cationic compound promotes the aggregation of the ink particles or increases the viscosity of the ink to suppress adsorption of the ink into a gap or the inside of the fiber constituting the cloth. As described above, since the cationic compound holds the ink on the surface of the cloth, the color developing properties of the ink in a recorded material is improved.

The cationic compound is not particularly limited, examples thereof include metal salts, acids, cationic organic compounds, and the like, and as the cationic organic compound, a cationic resin (cationic polymer), a cationic surfactant, and the like can be used. Among these, the metal salt is preferably a polyvalent metal salt, and the cationic organic compound is preferably a cationic resin. Examples of the acid preferably include organic acids and inorganic acids, and may be organic acids. Therefore, the cationic compound is preferably those selected from a cationic resin, an organic acid, and a polyvalent metal salt in that the obtained image quality, abrasion resistance, gloss, and the like are particularly excellent.

The metal salt is preferably a polyvalent metal salt, but a metal salt other than the polyvalent metal salt can also be used. Among these cationic compounds, at least one selected from a metal salt and an organic acid from the viewpoint of excellent reactivity with the components contained in the ink is preferably used. In addition, a plurality of types of cationic compounds can be used in combination.

A polyvalent metal salt is a compound formed of a divalent or higher metal ion and an anion. Examples of the divalent or higher metal ion include ions such as calcium, magnesium, copper, nickel, zinc, barium, aluminum, titanium, strontium, chromium, cobalt, and iron. Among the metal ions constituting these polyvalent metal salts, at least one of calcium ion and magnesium ion is preferable from the viewpoint of excellent aggregation of ink components.

The anion constituting the polyvalent metal salt is an inorganic ion or an organic ion. That is, the polyvalent metal salt in the present disclosure is formed of inorganic ions or organic ions and polyvalent metals. Examples of such inorganic ions include chloride ion, bromine ion, iodine ion, nitrate ion, sulfate ion, hydroxide ion, and the like. Examples of the organic ion include an organic acid ion, and examples thereof include a carboxylic acid ion.

The polyvalent metal compound may be an ionic polyvalent metal salt, and particularly when the polyvalent metal salt is a magnesium salt or a calcium salt, the stability of the pretreatment agent becomes more favorable. The counterion of the polyvalent metal may be either an inorganic acid ion or an organic acid ion.

Specific examples of the polyvalent metal salts include calcium carbonate such as heavy calcium carbonate and light calcium carbonate, calcium nitrate, calcium chloride, calcium sulfate, magnesium sulfate, calcium hydroxide, magnesium chloride, magnesium carbonate, barium sulfate, barium chloride, zinc carbonate, zinc sulfide, aluminum silicate, calcium silicate, magnesium silicate, copper nitrate, calcium acetate, magnesium acetate, aluminum acetate, calcium propionate, magnesium propionate, aluminum propionate, calcium lactate, magnesium lactate, aluminum lactate, and the like. These polyvalent metal salts may be used alone or in combination of two or more. Among these, at least one of magnesium sulfate, calcium nitrate, aluminum lactate, and calcium propionate is preferable from a viewpoint of obtaining sufficient solubility in water. In addition, these metal salts may have hydration water in the form of a raw material.

Examples of the metal salt other than the polyvalent metal salt include monovalent metal salts such as sodium salt and potassium salt, and examples thereof include sodium sulfate, potassium sulfate, and the like.

Examples of appropriate organic acids include poly(meth)acrylic acid, acetic acid, propionic acid, glycolic acid, malonic acid, malic acid, maleic acid, ascorbic acid, succinic acid, glutaric acid, fumaric acid, citric acid, tartrate acid, lactic acid, sulfonic acid, orthophosphoric acid, pyrrolidone carboxylic acid, pyrone carboxylic acid, pyrrole carboxylic acid, furan carboxylic acid, pyridine carboxylic acid, coumarin acid, thiophene carboxylic acid, nicotinic acid, derivatives of these compounds, or salts thereof. The organic acid may be used alone or in combination of two or more. Salts of organic acids that are metal salts are included in the metal salts.

Examples of the inorganic acid include sulfuric acid, hydrochloric acid, nitric acid, phosphoric acid, and the like. The inorganic acid may be used alone or in combination of two or more.

Examples of the cationic resin (cationic polymer) include a cationic urethane-based resin, a cationic olefin-based resin, a cationic amine-based resin, a cationic surfactant, and the like.

Commercially available products can be used as the cationic urethane-based resin, and for example, Hydran CP-7010, CP-7020, CP-7030, CP-7040, CP-7050, CP-7060, CP-7610 (product name, manufactured by DIC Corporation), Superflex 600, 610, 620, 630, 640, 650 (product name, manufactured by DKS Co., Ltd.), urethane emulsion WBR-2120C, WBR-2122C (product name, Taisei Fine Chemical Co., Ltd.), and the like can be used.

The cationic olefin-based resin is a resin having an olefin such as ethylene and propylene in the structural skeleton, and known ones can be appropriately selected and used. In addition, the cationic olefin-based resin may be in an emulsion state in which it is dispersed in a solvent containing water, an organic solvent, and the like. As the cationic olefin-based resin, a commercially available product can be used, and examples thereof include arrow base CB-1200 and CD-1200 (product name, manufactured by Unitika Ltd.).

As the cationic amine-based resin (cationic polymer), any resin having an amino group in the structure may be used, and known ones can be appropriately selected and used. Examples thereof include polyamine resin, polyamide resin, polyallylamine resin, and the like. A polyamine resin is a resin having an amino group in the main skeleton of the resin. Polyamide resin is a resin having an amide group in the main skeleton of the resin. The polyallylamine resin is a resin having a structure derived from an allyl group in the main skeleton of the resin.

In addition, commercially available products of a cationic amine-based resin include Unisense KHE103L (hexamethylenediamine/epichlorhydrin resin, 1% aqueous solution of pH of about 5.0, viscosity 20 to 50 (mPa·s), aqueous solution of solid content concentration of 50% by mass) manufactured by Senka Co., Ltd., Unisense KHE104L (dimethylamine/epichlorhydrin resin, 1% aqueous solution of pH of about 7.0, viscosity 1 to 10 (mPa·s), aqueous solution of solid content concentration of 20% by mass), and the like. In addition, specific examples of commercially available products of cationic polyamine-based resin include FL-14 (manufactured by SNF), Arafix 100, 251S, 255, 255LOX (manufactured by Arakawa Chemical Co., Ltd.), DK-6810, 6853, 6885; WS-4010, 4011, 4020, 4024, 4027, 4030 (manufactured by Seiko PMC), Papiogen P-105 (manufactured by Senka), Sumire's Resin 650 (30), 675A, 6615, SLX-1 (manufactured by Taoka Chemical Industry Co., Ltd.), Kachio Master (registered trademark) PD-1, 7, 30, A, PDT-2, PE-10, PE-30, DT-EH, EPA-SK01, TMHMDA-E (manufactured by Yokkaichi Chemical Co., Ltd.), Jetfix 36N, 38A, 5052 (manufactured by Satoda Kako Co., Ltd.), and the like.

Examples of allylamine resin include polyallylamine hydrochloride, polyallylamineamide sulfate, allylamine hydrochloride/diallylamine hydrochloride copolymer, allylamine acetate/diallylamine acetate copolymer, allylamine acetate/diallylamine acetate copolymer, allylamine hydrochloride/dimethylallylamine hydrochloride copolymer, allylamine/dimethylallylamine copolymer, polydiallylamine hydrochloride, polymethyldiallylamine hydrochloride, polymethyldiallylamineamide sulfate, polymethyldiallylamine acetate, polydiallyldimethylammonium chloride, diallylamine acetate/sulfur dioxide copolymer, diallylmethylethylammonium ethylsulfate/sulfur dioxide copolymer, methyldiallylamine hydrochloride/sulfur dioxide copolymer, diallyldimethylammonium chloride/sulfur dioxide copolymer, diallyldimethylammonium chloride/acrylamide copolymer, and the like.

Examples of the cationic surfactant include primary, secondary, and tertiary amine salt type compounds, alkylamine salts, dialkylamine salts, aliphatic amine salts, benzalconium salts, quaternary ammonium salts, quaternary alkylammonium salt, alkylpyridinium salt, sulfonium salt, phosphonium salt, onium salt, imidazolinium salt, and the like. Specific examples thereof include hydrochlorides such as laurylamine, coconut amine, and rosinamine, acetates and the like, lauryltrimethylammonium chloride, cetyltrimethylammonium chloride, benzyltributylammonium chloride, benzalkonium chloride, dimethylethyllaurylammonium ethyl sulfate, dimethylethyloctylammonium ethyl sulfate, trimethyllaurylammonium hydrochloride, cetylpyridinium chloride, cetylpyridinium bromide, dihydroxyethyllaurylamine, decyldimethylbenzylammonium chloride, dodecyldimethylbenzylammonium chloride, tetradecyldimethylammonium chloride, hexadecyldimethylammonium chloride, octadecyldimethylammonium chloride, and the like. Although the cationic surfactant functions as a cationic compound described later, the cationic surfactant may be contained in the ink composition. However, the cationic surfactant is more preferably contained in the pretreatment agent as a cationic compound.

A plurality of types of these cationic compounds may be used. In addition, when at least one of a polyvalent metal salt, an organic acid, and a cationic resin is selected among these cationic compounds, the aggregation action is more favorable, and thus an image of higher quality (particularly favorable color developing properties) can be formed.

A total content of the cationic compound in the pretreatment agent is, for example, 0.1% by mass or more and 20% by mass or less, preferably 1% by mass or more and 20% by mass or less, and more preferably 2% by mass or more and 15% by mass or less, with respect to the total mass of the pretreatment agent. Even when the cationic compound is shared by a solution or a dispersion, the solid content is preferably in the above range. When the content of the cationic compound is 1% by mass or more, the ability of the cationic compound to aggregate the components contained in the ink can be sufficiently obtained. In addition, when the content of the cationic compound is 30% by mass or less, the solubility or dispersibility of the cationic compound in the pretreatment agent become more favorable, and the storage stability of the pretreatment agent and the like can be improved.

### Pretreatment Agent Application Method

The application method is not particularly limited as long as the pretreatment agent can be adhered to at least a part of the region of the cloth. Examples of the application method include dip application in which a cloth is immersed in a pretreatment agent, roller application in which a pretreatment agent is adhered using a brush, a roller, a spatula, a roll coater, and the like, spray application in which a pretreatment agent is sprayed by a spray device and the like, ink jet application in which a pretreatment agent is adhered by an ink jet method, and the like. Among these, dip application, roller application, spray application, and the like, which has a simple configuration of the device and can quickly adhere a pretreatment agent, are preferably used.

An application amount of the pretreatment agent is not particularly limited, but when a cloth is used as a recording medium, it is preferable to apply 5 to 30 g per A4 size area, more preferable to apply 10 to 25 g, and still more preferable to apply 15 to 25 g.

### Drying Method

A drying method is not particularly limited, and examples thereof include drying with a hot press machine, an oven, and the like. A heating temperature is preferably 100° C. or higher, more preferably 110° C. to 200° C., and still more preferably 120° C. to 180° C. In addition, a heating time may be within 2 minutes. When the heating temperature is 100° C. or higher, fixing properties of the cationic compound tends to be favorable. A press pressure when using a hot press machine is not particularly limited, but is preferably about 3.0 to 5.0 N/cm².

### 2.4. Heating and Drying Step

The ink jet recording method according to the present embodiment may include a step of heating and drying an ink adhered to a recording medium after the white ink adhesion step.

The heating and drying method is not particularly limited, and examples thereof include a heat press method, a normal pressure steam method, a high pressure steam method, a thermofix method, and the like. A heat source at the time of heating and drying is not particularly limited, but for example, an infrared lamp and the like can be used.

The heating and drying temperature is preferably a temperature at which the resin particles of the ink are fused and the medium such as moisture volatilizes. For example, the heating and drying temperature is preferably about 100° C. or higher and about 200° C. or lower, more preferably 180° C. or lower, and still more preferably 160° C. or lower. Here, the heating and drying temperature in the heating and drying step refers to a surface temperature of an image and the like formed on a recording medium. A time for heating and drying is not particularly limited, but is preferably 30 seconds or more and 20 minutes or less, and more preferably 5 minutes or more and 10 minutes or less.

Here, it is more preferable that a maximum temperature of the recording medium in the heating and drying step is 180° C. or less, and a duration of the heating and drying step is 10 minutes or less. By doing so, it is possible to form an image at a higher speed while maintaining favorable color developing properties of the white image. Here, the duration of the heating and drying step means the time during which the recording medium is heated by the heat source.

### 2.5. Other Steps

The ink jet recording method according to the present embodiment may include a step of washing the printed recording medium with water and a step of performing heating and drying again, after the heating and drying step. In washing with water, depending on the necessity, as a soaping treatment, components such as ink that was not fixed on the recording medium may be washed away using a hot soap solution and the like.

### 3. EXAMPLE

Hereinafter, the present disclosure will be described in more detail with reference to examples, but the present disclosure is not limited to these examples. Hereinafter, “%” is based on mass unless otherwise specified.

### 3.1. Preparation of White Ink Jet Ink Composition

Each component is put in a container so as to have the compositions shown in Tables 1 and 2, mixed and stirred with a magnetic stirrer for 2 hours, and then filtered through a membrane filter having a pore size of 5 μm to obtain a white ink jet ink composition according to examples and comparative examples. Unless otherwise specified, numerical values in the table represent the content, and the unit thereof is mass %. In addition, contents of the color material and the resin particles represent the contents in terms of solid content.

TABLE 1

| | | | Examples | | | | | | Comparative Examples | | |
|---|---|---|---|---|---|---|---|---|---|---|---|
| Material | | | 1 | 2 | 3 | 4 | 5 | 6 | 1 | 2 | 3 |
| Color | Titanium | Titanium dioxide | — | — | — | — | — | — | — | — | — |
| material | dioxide | slurry | | | | | | | | | |
| | Hollow | Dispersion A | 10.0 | 10.0 | — | 10.0 | 10.0 | 10.0 | 10.0 | — | — |
| | resin | SX868B | — | — | — | — | — | — | — | 10.0 | 10.0 |
| | particles | V1004 | — | — | — | — | — | — | — | — | — |
| | | Dispersion B | — | — | 10.0 | — | — | — | — | — | — |
| Resin particles | | Movinyl 6899D | — | — | — | — | — | — | 5.0 | 5.0 | — |
| (fixed resin) | | Movinyl 6718 | 5.0 | — | — | — | — | — | — | — | — |
| | | Movinyl 6751D | — | 5.0 | 5.0 | 5.0 | 5.0 | — | — | — | 5.0 |
| | | Superflex 820 | — | — | — | — | — | — | — | — | — |
| | | Superflex 740 | — | — | — | — | — | 5.0 | — | — | — |
| Organic | | Glycerin | 3.0 | 3.0 | 3.0 | 3.0 | 3.0 | 3.0 | 3.0 | 3.0 | 3.0 |
| solvent | Alkanediol | 3-Methyl-1,3- | 20.0 | 20.0 | 20.0 | 15.0 | — | 20.0 | 20.0 | 20.0 | 20.0 |
| | | butanediol | | | | | | | | | |
| | | 1,3-Butanediol | — | — | — | — | 20.0 | — | — | — | — |
| | Monovalent | Triethylene glycol | 1.0 | 1.0 | 1.0 | 1.0 | 1.0 | 1.0 | 1.0 | 1.0 | 1.0 |
| | alcohol | monobutyl ether | | | | | | | | | |

| | | | | | | | | | | |
|---|---|---|---|---|---|---|---|---|---|---|
| pH regulator | triethanolamine | 0.5 | 0.5 | 0.5 | 0.5 | 0.5 | 0.5 | 0.5 | 0.5 | 0.5 |
| Surfactant | BYK348 | 0.3 | 0.3 | 0.3 | 0.3 | 0.3 | 0.3 | 0.3 | 0.3 | 0.3 |
| Water | Pure water | Residue | Residue | Residue | Residue | Residue | Residue | Residue | Residue | Residue |

| Whiteness L* after heat drying | A | A | S | A- | A | A | A | B | B |
|---|---|---|---|---|---|---|---|---|---|
| Fabric followingness | A | A | A | A | A | A | B | B | A |
| (cotton T-shirts fabric) | | | | | | | | | |
| Ejection reliability | S | S | A- | A | A | A | S | A- | A- |
| Pigment precipitation rate | A | A | A | A | A | A | A | A | A |
| Young's modulus of ink dry | A | S | S | S | S | S | B | B | S |
| coating film | | | | | | | | | |
| Resin Tg difference | 125 | 165 | 125 | 165 | 165 | 165 | 80 | 60 | 145 |
| (hollow particles—resin | | | | | | | | | |
| particles)(° C.) | | | | | | | | | |
| | | | | | Comparative Examples | | | | |
| | | Material | | | 4 | 5 | 6 | 7 | 8 |
| | | Color | Titanium | Titanium dioxide | — | — | — | 10.0 | 10.0 |
| | | material | dioxide | slurry | | | | | |
| | | | Hollow | Dispersion A | — | — | 10.0 | — | — |
| | | | resin | SX868B | — | — | — | — | — |
| | | | particles | V1004 | 10.0 | 10.0 | — | — | — |
| | | | | Dispersion B | — | — | — | — | — |
| | | Resin particles | | Movinyl 6899D | 5.0 | — | — | 5.0 | — |
| | | (fixed resin) | | Movinyl 6718 | — | — | — | — | — |
| | | | | Movinyl 6751D | — | 5.0 | — | — | 5.0 |
| | | | | Superflex 820 | — | — | 5.0 | — | — |
| | | | | Superflex 740 | — | — | — | — | — |
| | | Organic | | Glycerin | 3.0 | 3.0 | 3.0 | 3.0 | 3.0 |
| | | solvent | Alkanediol | 3-Methyl-1,3- | 20.0 | 20.0 | 20.0 | 20.0 | 20.0 |
| | | | | butanediol | | | | | |
| | | | | 1,3-Butanediol | — | — | — | — | — |
| | | | Monovalent | Triethylene glycol | 1.0 | 1.0 | 1.0 | 1.0 | 1.0 |
| | | | alcohol | monobutyl ether | | | | | |

| | | | | | | |
|---|---|---|---|---|---|---|
| pH regulator | triethanolamine | 0.5 | 0.5 | 0.5 | 0.5 | 0.5 |
| Surfactant | BYK348 | 0.3 | 0.3 | 0.3 | 0.3 | 0.3 |
| Water | Pure water | Residue | Residue | Residue | Residue | Residue |

| | | | | | |
|---|---|---|---|---|---|
| Whiteness L* after heat drying | B | B | A | S | S |
| Fabric followingness | B | A | B | B | A |
| (cotton T-shirts fabric) | | | | | |
| Ejection reliability | A | A | A | B | B |
| Pigment precipitation rate | A | A | A | B | B |
| Young's modulus of ink dry | B | S | B | B | S |
| coating film | | | | | |
| Resin Tg difference | 40 | 125 | 90 | — | — |
| (hollow particles—resin | | | | | |
| particles)(° C.) | | | | | |

TABLE 2

| Material | | | Example 7 | Example 8 |
|---|---|---|---|---|
| Color material | | Dispersion A | 10.0 | 10.0 |
| Resin particles | | Superflex 740 | 5.0 | — |
| (fixed resin) | | Superflex 500M | — | 5.0 |
| | | Glycerin | 3.0 | 3.0 |
| Organic | Alkanediol | 3-Methyl-1,3-butanediol | 20.0 | 20.0 |
| solvent | Monovalent | Triethylene glycol | 1.0 | 1.0 |
| | alcohol | monobutyl ether | | |

| | | | |
|---|---|---|---|
| pH regulator | Triethanolamine | 0.5 | 0.5 |
| Surfactant | BYK348 | 0.3 | 0.3 |
| Water | Pure water | Residue | Residue |
| Whiteness L* after | Treatment liquid | S | A |
| heat drying | composition 1 | | |
| | Treatment liquid | S | A |
| | composition 2 | | |
| | Treatment liquid | A | A |
| | composition 3 | | |
| Bleeding after heat | Treatment liquid | S | A |
| drying (ink | composition 1 | | |
| bleeding due | Treatment liquid | S | A |
| to insufficient | composition 2 | | |
| pinning) | Treatment liquid | A | B |
| | composition 3 | | |

| | | |
|---|---|---|
| Fabric followingness (cotton T-shirts fabric) | A | A |
| Pigment precipitation rate | A | A |

The abbreviations and footnotes in Tables 1 and 2 are as follows.
Titanium dioxide slurry: anionic; average particle size 400 nm
Dispersion A: Production Example 1 below; Tg=124° C.; styrene-acrylic resin; anionic; average particle size 280 nm
SX868B: manufactured by JSR Corporation; Tg=109° C.; styrene-acrylic resin; anionic; average particle size 500 nm
V1004: manufactured by Nippon Zeon Corporation; Tg=87° C.; styrene-acrylic resin; anionic; average particle size 314 nm
Dispersion B: Production Example 2 below; Tg=131° C.; styrene-acrylic resin; anionic; average particle size 700 nm
Movinyl 6899D; manufactured by Nippon Synthetic Chemical Industry Co., Ltd.; Tg=46° C.; acrylic resin; anionic
Movinyl 6718; manufactured by Nippon Synthetic Chemical Industry Co., Ltd.; Tg=3° C.; acrylic resin; anionic
Movinyl 6751D; manufactured by Nippon Synthetic Chemical Industry Co., Ltd.; Tg=−32° C.; acrylic resin; anionic
Superflex 820: manufactured by DKS Co., Ltd.; Tg=46° C.; urethane resin; anionic
Superflex 740; manufactured by DKS Co., Ltd.; Tg=−34° C.; urethane resin; anionic
Glycerin: Standard boiling point 290° C.
Triethylene glycol: Standard boiling point 287° C.
3-Methyl-1,3-butanediol: Standard boiling point 203° C.
1,3-Butanediol standard boiling point 203° C.
BYK348: manufactured by BYK; polyether-modified organosiloxane
Dispersion A: Production Example 1 below; Tg=124° C.; styrene-acrylic resin; anionic; average particle size 280 nm
Superflex 500M; manufactured by DKS Co., Ltd.; Tg=−39° C.; urethane resin; nonionic

In addition, Table 1 shows the difference between the Tg of the hollow resin particles and the Tg of the resin particles, in addition to the evaluation results.

### 3.2. Evaluation Method

### 3.2.1. Preparation of Dispersion

The dispersion A and the dispersion B of the hollow resin particles were prepared as follows.

### Production Example 1

### (1) Synthesis of Seed Particle Emulsion

A four-necked separable flask equipped with a stirrer, a thermometer, a cooler, and a dropping funnel was charged with 726.0 parts by mass of deionized water, 5.0 parts by mass of methyl methacrylate, and 0.1 parts by mass of methacrylic acid, and heated while stirring. Next, when the internal temperature in the separable flask reached 70° C., 1.0 part by mass of a 10% by mass ammonium persulfate aqueous solution was added, and the mixture was heated at 80° C. for 20 minutes.

On the other hand, 141.0 parts by mass of methyl methacrylate, 94.9 parts by mass of methacrylic acid, 5.0 parts by mass of sodium alkylbenzene sulfonate (Neogen SF-20, manufactured by DKS Co., Ltd.) as an anionic emulsifier, and 120.0 parts by mass of deionized water were emulsified with a homodisper to obtain a pre-emulsion, and then the resultant product was put into a dropping funnel.

Next, while maintaining the internal temperature in the separable flask at 80° C., the pre-emulsion obtained above was uniformly added dropwise over 3 hours, and at the same time, 10.0 parts by mass of a 10% by mass ammonium persulfate aqueous solution was uniformly added dropwise over 3 hours. After completion of the dropping, the mixture was aged at 80° C. for 3 hours, cooled, and then filtered using a 120-mesh filter cloth to obtain a seed particle emulsion.

### (2) First-Stage Polymerization

A four-necked separable flask equipped with a stirrer, a thermometer, a cooler, and a dropping funnel was charged with 188.2 parts by mass of deionized water, and 66.0 parts by mass of the obtained seed particle emulsion was added dropwise, and heated to 80° C. while stirring. On the other hand, 2.4 parts by mass of butyl acrylate, 1.1 parts by mass of butyl methacrylate, 19.5 parts by mass of methyl methacrylate, 0.7 parts by mass of methacrylic acid, 5.0 parts by mass of sodium alkylbenzene sulfonate (Neogen SF-20, manufactured by DKS Co., Ltd.), and 55.3 parts by mass of deionized water were emulsified with homodisper to obtain a pre-emulsion 1, and then the resultant product was put into a dropping funnel.

Next, while maintaining the internal temperature in the separable flask at 80° C., the pre-emulsion 1 obtained above was uniformly added dropwise over 30 minutes, and at the same time, 1.2 parts by mass of a 10% by mass sodium persulfate aqueous solution was uniformly added dropwise over 30 minutes.

### (3) Second-Stage Polymerization

20.5 parts by mass of styrene, 0.5 parts by mass of 1,3-diethylbenzene, 5.0 parts by mass of sodium alkylbenzene sulfonate (Neogen SF-20, manufactured by DKS Co., Ltd.), and 51.8 parts by mass of deionized water were emulsified with homodisper to obtain a pre-emulsion 2, and then the resultant product was put into a dropping funnel.

Next, while maintaining the internal temperature in the separable flask at 80° C., 1 hour after the dropping of the pre-emulsion 1 was completed, the pre-emulsion 2 obtained above was uniformly dropped over 60 minutes, and at the same time, 3.5 parts by mass of a 10% by mass sodium persulfate aqueous solution was uniformly added dropwise over 60 minutes.

After the dropping of the pre-emulsion 2 was completed, 7.5 parts by mass of 28% by mass ammonia water was dropped and aged at 80° C. for 1 hour in order to swell and dissolve the seed particles. After cooling, the mixture was filtered using a 120-mesh filter cloth to obtain a hollow resin dispersion A.

### Production Example 2

Hollow resin dispersion B was obtained in the same manner as in Production Example 1 except that the amount of styrene in the second-stage polymerization was 60.1 parts by mass in Production Example 1.

### 3.2.2. Pretreatment of Cloth

As a cloth for an object to be treated, a T-shirts (black, 100% cotton) manufactured by Hanes was sprayed with the pretreatment agent of each Example/Comparative Example so as to be 15 to 20 g per A4 size, then dried at 130° C. for 1 hour using a heat press machine (SF-54TEN manufactured by Itsumi) so that a press pressure was 4.2 N/cm², and the temperature was returned to 25° C. to obtain a treated cloth.

As the composition of the pretreatment agent, as the cationic compound, an aqueous solution of calcium chloride dihydrate dissolved in pure water was used, and the following treatment liquid compositions 1 to 3 having different concentrations of calcium chloride dihydrate were used.

Treatment liquid composition 1: 9.0% by mass

Treatment liquid composition 2: 6.0% by mass

Treatment liquid composition 3: 3.0% by mass

In each of Examples and Comparative Examples in Table 1, the treatment liquid composition 2 was used. In Table 2, each treatment liquid composition shown in Table 2 was used for each Example. In addition, the application amount of the pretreatment agent was 15 g/A4 in each case.

### 3.2.3. Recording Method

An SC-F2000 manufactured by Seiko Epson was prepared as a recording device. The white ink jet ink compositions of each Example/Comparative Example were filled, and the images described in each evaluation method were printed on the pretreated cloths described above or in the table, respectively. The adhesion amount of the white ink jet ink composition was 100 mg/inch² in all examples.

3.2.4. Evaluation of Whiteness L* after Heating and Drying

After ink jet applying the white ink jet ink composition that was sufficiently stirred to recover the precipitation to the cloth pretreated by the above method, heating and drying treatment was performed at 150° C. for 5 minutes using a conveyor drying oven (manufactured by M&R: Economax D conveyor drying oven). Then, the printed cloth was immersed in 2 L of water at a water temperature of 25° C., the container was shaken at a frequency of 1 time/2 seconds, and washed for 5 minutes to remove moisture with a towel, and then the printed cloth was subjected to heating and drying treatment at 150° C. for 5 minutes. Then, L* was measured using a colorimeter (Spectrolino manufactured by Gretag), and determined according to the following criteria, and the results are shown in the table.

S: 85≤L*

A: 70≤L*<85

A−: 60≤L*<70

B: L*<60

### 3.2.5. Evaluation of Fabric Followingness (Cotton T-Shirts Fabric)

After ink jet applying the ink composition that was sufficiently stirred to recover the precipitation to the cloth pretreated by the above method in each ink adhesion amount described in Example, heating and drying treatment was performed at 150° C. for 5 minutes using a conveyor drying oven (manufactured by M&R: Economax D conveyor drying oven). After allowing the printed cloth to stand still and returning the temperature to 25° C., a 3×15 cm piece of cloth was prepared. In a state in which one of the above-mentioned cloth pieces was fixed, the cloth piece was stretched by 5 cm in a long axis direction, the state of the printed image at the time was visually observed, and determined according to the following criteria, and the results are shown in the table.

A: There is no crack in the image

B: There is a crack in the image

### 3.2.6. Evaluation of Ejection Reliability

The color ink cartridge of the recording device was filled with the white ink jet ink composition of each example, a nozzle check image was printed on a transparent PET film using a nozzle check function built into the SC-F2000, the nozzle check image was normally printed, it was confirmed that ink was normally ejected on all nozzles, and then an automatic head cleaning function was set to OFF, and the cartridge was allowed to stand for 15 minutes in an environment of room temperature of 25° C. and relative humidity of 40% in a state in which an anti-drying cap was not mounted on the head nozzles. In addition, the cartridge was allowed to stand for 24 hours in a state in which the anti-drying cap was mounted. After that, the nozzle check image was printed again, the number of nozzles on which the nozzle check image was not printed was counted, determination was made according to the following criteria, and the results are shown in the table. When there was a nozzle slip-out, the recovery operation was performed 1 to 5 times using the head cleaning function built into the SC-F2000, a nozzle check image was printed, the number of nozzle slip-outs was counted, the determination was made according to the following criteria, and the results are shown in the table.

S: There is no nozzle slip-out

A: Nozzle slips out, but there is no nozzle slip-out after one recovery operation

A−: Nozzle slips out, but there is no nozzle slip-out within 5 recovery operations

B: Nozzle slips out, and there is nozzle slip-out even after performing recovery operations 5 times.

### 3.2.7. Evaluation of Pigment Precipitation Rate

100 mL of the white ink jet ink composition of each example, which was sufficiently stirred to recover the precipitation, was poured into a glass screw tube bottle (laboratory screw tube bottle 110 cc manufactured by As One Corporation), and 5 mL of ink was collected at 10 mm below the ink liquid level using a pipette to prepare a pre-test sample. After that, the screw tube bottle was allowed to stand in an environment of 20° C., and after 168 hours, and 5 mL of ink was collected at 10 mm below the ink liquid level using a pipette again to prepare a post-test sample. The pre-test sample and the post-test sample were sufficiently stirred to recover the precipitation, 0.5 mg of each of the pre-test and post-test samples were collected using a pipette, and diluted with pure water using a 1 L volumetric flask to prepare 1 L of diluted solution, and absorbance (Abs) was measured using a spectrophotometer (U-3900H manufactured by Hitachi High-Tech Science). Subsequently, the percentage of change in absorbance was calculated according to the following formula, and determined according to the following criteria, and the results are shown in the table.

Percentage of change in absorbance: {(Abs after test)−(Abs before test)}/(Abs before test)×100

A: −5% or more

B: Less than −5%

### 3.2.8. Measurement of Young's Modulus of Ink-Dried Coating Film

A frame was provided with silicon rubber (thickness: 5 mm) on a flat plate of stainless steel (SUS), 10 g of each ink composition prepared above was put into an opening of 3 cm×19 cm, and dried overnight in the atmosphere. Then, the frame was heat-treated at 160° C. for 15 minutes, and the coating film on SUS was obtained. In addition, the coating film was peeled off from the SUS to obtain a coating film.

Regarding the obtained coating film, a stress-strain curve was measured under conditions of a test piece size width of 10 mm, height of 30 mm, and tensile speed of 100 mm/min using TENSILON universal testing machine (product name: RTG-1250 manufactured by A & D Co., Ltd.). Young's modulus [MPa] was obtained by linear regression between the stress-strain curve and the strain of 0.05% to 0.25%. A film thickness of the coating film required for the present measurement was obtained from actual measurement using a micrometer (product name “MDH-25M” manufactured by Mitutoyo Co., Ltd.). The Young's modulus of the coating film obtained by drying each white ink jet ink composition is shown in the table.

### 3.2.9. Difference Between Tg of Hollow Resin Particles and Tg of Resin Particles

A glass transition temperature of the hollow resin particles and the resin particles used in each example was obtained using a differential scanning calorimeter “DSC7000” manufactured by Hitachi High-Tech Science Co., Ltd. according to the plastic transition temperature measurement method JIS K7121, and the difference was described in the table.

3.2.10. Evaluation of Bleeding after Heating and Drying

Four rows of gradation patterns (patch size: 1×1 cm, 10 gradations (20% to 200%), patch interval 0.25 mm) were printed on the cloth pretreated by the above method using an ink jet device (SC-F2000) at 0.25 mm intervals, and subjected to heating and drying treatment at 150° C. for 5 minutes using a conveyor drying oven (Economax D conveyor drying oven: manufactured by M&R). The boundary between the patches was confirmed with a microscope, and if the boundary between the patches disappeared due to bleeding, it was determined as fail, evaluated according to the following criteria, and described in the table.

S: Pass in case of Duty 200%

A: Fail in case of Duty 100% or more and less than Duty 200%.

B: Fail in case of less than Duty 100%

### 3.3. Evaluation Results

It was determined that the white ink jet ink composition of each example, which contains hollow resin particles, resin particles, and water, has a glass transition temperature of the hollow resin particles of 120° C. or higher, and has a glass transition temperature of the resin particles of 5° C. or lower, has favorable color developing properties (whiteness L*), favorable storage stability (pigment precipitation rate), and favorable fabric followingness of an image.

The above-mentioned embodiments and modifications are merely examples, and the present disclosure is not limited thereto. For example, it is also possible to appropriately combine each embodiment and each modification.

For example, the present disclosure includes a configuration substantially the same as the configuration described in the embodiment, for example, a configuration having the same function, method, and result, or a configuration having the same object and effect. The present disclosure also includes a configuration in which a non-essential part of the configuration described in the embodiment is replaced. In addition, the present disclosure includes a configuration that exhibits the same effects as the configuration described in the embodiment or a configuration that can achieve the same object. In addition, the present disclosure includes a configuration in which a known technique is added to the configuration described in the embodiment.

The following contents are derived from the above-described embodiments and modifications.

The white ink jet ink composition contains hollow resin particles, resin particles, and water, a glass transition temperature of the hollow resin particles is 120° C. or higher, and a glass transition temperature of the resin particles is 5° C. or lower.

According to the white ink jet ink composition, the precipitation of a white color material can be favorably suppressed by using the hollow resin particles as the white color material. In addition, when hollow resin particles are used, the structure is easily broken during heating and drying and the color developing properties are likely to be deteriorated. However, by using the hollow resin particles having a glass transition temperature of 120° C. or higher, the deterioration of the color developing properties can be suppressed. On the other hand, when hollow resin particles having a high glass transition temperature are used, the elasticity of the dry coating film of the white ink jet ink composition may decrease and the followingness to the recording medium (cloth fabric) may decrease. However, according to the white ink jet ink composition, by further using resin particles having a glass transition temperature of 5° C. or lower as resin particles other than hollow resin particles, the followingness to the recording medium can be improved.

In the white ink jet ink composition, the hollow resin particles may contain an acrylic resin.

According to the white ink jet ink composition, hollow resin particles having a glass transition temperature of 120° C. or higher can be easily produced, and the glass transition temperature can be adjusted more easily.

In the white ink jet ink composition, the resin particles may contain any one selected from a urethane-based resin and an acrylic resin.

According to the white ink jet ink composition, it is possible to form an image having more favorable fabric followingness.

In the white ink jet ink composition, the glass transition temperature of the resin particles may be −35° C. or higher.

According to the white ink jet ink composition, the storage stability of the white ink jet ink composition can be further enhanced.

In the white ink jet ink composition, the Young's modulus of the dry coating film of the white ink jet ink composition may be 20 MPa or less.

According to the white ink jet ink composition, it is possible to form an image having more favorable fabric followingness.

In the white ink jet ink composition, at least one of the resin particles and the hollow resin particles may contain an anionic resin.

According to the white ink jet ink composition, when the white ink jet ink composition comes into contact with a cationic compound, at least one of the resin particles and the hollow resin particles tends to aggregate, and thus an image with excellent image quality can be obtained.

In the white ink jet ink composition, alkanediol having a standard boiling point of 240° C. or lower is further contained as a water-soluble organic solvent, the alkanediol is an alkanediol having at least one hydroxyl group bonded to other than the terminal of the alkane chain and having 4 to 6 carbon atoms, and a content of the alkanediol having a standard boiling point of 240° C. or lower may be 75.0% by mass or more with respect to the total amount of the water-soluble organic solvent.

According to the white ink jet ink composition, even if the white image formed on the recording medium is rapidly heated and dried, it is possible to suppress the deterioration in the whiteness of the white image.

In the white ink jet ink composition, the absolute value of the difference between the glass transition temperature of the hollow resin particles and the glass transition temperature of the resin particles may be 125° C. or higher.

According to the white ink jet ink composition, it is possible to further improve the color developing properties of the image and further improve the fabric followingness.

The ink jet recording method includes a white ink adhesion step of ejecting the white ink jet ink composition from a recording head and adhering thereof to a recording medium.

According to the ink jet recording method, by using the hollow resin particles as a white color material, the precipitation of the white color material can be favorably suppressed. In addition, when hollow resin particles are used, the structure is easily broken during heating and drying and the color developing properties are likely to be deteriorated. However, by using the hollow resin particles having a glass transition temperature of 120° C. or higher, the deterioration of the color developing properties can be suppressed. In addition, according to this ink jet recording method, since resin particles having a glass transition temperature of 5° C. or lower, as resin particles other than hollow resin particles, are further used, it is possible to form an image having favorable followingness to a recording medium.

The ink jet recording method is an ink jet recording method in which the recording medium is a cloth.

According to the ink jet recording method, it is possible to form an image having favorable followingness to the cloth.

The ink jet recording method further includes a heating step of heating the recording medium after the white ink adhesion step. A maximum temperature of the recording medium in the heating step may be 180° C. or lower, and the duration of the heating step may be 10 minutes or less.

According to the ink jet recording method, an image can be formed at a higher speed while maintaining favorable color developing properties of a white image.

What is claimed is:

1. A white ink jet ink composition comprising:
hollow resin particles;
resin particles; and
water, wherein
a glass transition temperature of the hollow resin particles is 120° C. or higher, and
a glass transition temperature of the resin particles is 5° C. or lower.

2. The white ink jet ink composition according to claim 1, wherein
the hollow resin particles contain an acrylic resin.

3. The white ink jet ink composition according to claim 1, wherein
the resin particles contain any one selected from a urethane-based resin and an acrylic resin.

4. The white ink jet ink composition according to claim 1, wherein
the glass transition temperature of the resin particles is −35° C. or higher.

5. The white ink jet ink composition according to claim 1, wherein
a Young's modulus of a dry coating film of the white ink jet ink composition is 20 MPa or less.

6. The white ink jet ink composition according to claim 1, wherein
at least one of the resin particles and the hollow resin particles contains an anionic resin.

7. The white ink jet ink composition according to claim 1, further comprising:
alkanediol having a standard boiling point of 240° C. or lower as a water-soluble organic solvent, wherein
the alkanediol has at least one hydroxyl group bonded to other than a terminal of an alkane chain and has 4 to 6 carbon atoms, and a content of the alkanediol having a standard boiling point of 240° C. or lower is 75.0% by mass or more with respect to a total amount of the water-soluble organic solvent.

8. The white ink jet ink composition according to claim 1, wherein
an absolute value of a difference between the glass transition temperature of the hollow resin particles and the glass transition temperature of the resin particles is 125° C. or higher.

9. An ink jet recording method comprising:
a white ink adhesion step of ejecting the white ink jet ink composition according to claim 1 from a recording head and adhering the ejected composition to a recording medium.

10. The ink jet recording method according to claim 9, wherein
the recording medium is a cloth.

11. The ink jet recording method according to claim 9, further comprising:
a heating step of heating the recording medium after the white ink adhesion step, wherein
a maximum temperature of the recording medium in the heating step is 180° C. or lower.
